(19) United States
(12) Patent Application Publication
(10) Pub. No.: US 2012/0059746 A1
(43) Pub. Date: Mar. 8, 2012

(54) Methodology and System for Cash Handling and Accountancy Services

(75) Inventors: Vincent P. Thomas, Royal Oak, MI (US); Steven Robert, Rochester Hills, MI (US); John A. Schmid, Harrison Township, MI (US)

(73) Assignee: Automated Payment Highway, Inc., Troy, MI (US)

(21) Appl. No.: 13/220,881

(22) Filed: Aug. 30, 2011

Related U.S. Application Data
(60) Provisional application No. 61/380,848, filed on Sep. 8, 2010.

(51) Int. Cl. G06Q 40/00

(52) U.S. Cl. 705/30

(57) ABSTRACT

A method is disclosed. The method includes the steps of: accessing, at a computer at a customer end, Internet web-page content from a provider end for obtaining access to virtual cash handling and accountancy services from the provider end for managing financial data. The financial data includes one or more cash handling data entries and one or more accountancy data entries. The managing step further includes the step of reconciling the one or more cash handling data entries with the one or more accountancy data entries. A system is also disclosed.

### CROSS-REFERENCE TO RELATED APPLICATIONS

This U.S. patent application claims priority under 35 U.S.C. §119(e) to U.S. Provisional Application: 61/380,848, filed on Sep. 8, 2010, the disclosure of which is considered part of the disclosure of this application and is hereby incorporated by reference in its entirety.

### TECHNICAL FIELD

The disclosure relates to a methodology and system for cash handling and accountancy services.

### BACKGROUND

The World Wide Web provides the ability to transmit and receive information electronically. Because of the World Wide Web, a new form of commerce called “electronic commerce” or “e-commerce” was born.

E-commerce rendered obsolete, or, in the alternative, has contributed to a significant improvement over traditional methodologies of conducting commerce. Thus, it may be said that e-commerce has provided a significant contribution to the arts by increasing efficiencies. Although e-commerce has resulted in increased efficiencies, improvements are nevertheless continuously being sought in order to advance the art.

### DESCRIPTION OF THE DRAWINGS

The disclosure will now be described, by way of example, with reference to the accompanying drawings, in which:

FIG. 1 is a view of an exemplary system for cash handling and accountancy services.

FIG. 1A illustrates a flow diagram of a procedure conducted by a provider end of the system of FIG. 1 when incoming funds/a deposit is conveyed from a payer to a customer at a customer end.

FIG. 1B illustrates a flow diagram of a procedure conducted by a provider end of the system of FIG. 1 when outgoing funds/a withdrawal is conveyed from a customer at a customer end to a payee.

FIG. 1C illustrates exemplary web-page content associated with an output of the cash and accounting activity of the system of FIG. 1.

FIG. 2 illustrates an exemplary method for initializing a customer end with a provider end of the system of FIG. 1.

FIG. 3 illustrates an exemplary billing methodology of the system of FIG. 1.

FIGS. 4A-4D illustrate exemplary web-page content associated with the billing methodology of FIG. 3.

FIG. 5 illustrates an exemplary payment methodology of the system of FIG. 1.

FIGS. 6A-6D illustrate exemplary web-page content associated with the payment methodology of FIG. 5.

FIG. 7 illustrates an exemplary spending methodology of the system of FIG. 1.

FIGS. 8A-8E illustrate exemplary web-page content associated with the spending methodology of FIG. 7.

FIGS. 9A-9C illustrate exemplary web-page content associated with an output of the cash and accounting activity of the system of FIG. 1.

FIG. 10 illustrates a computer in communication with a printer for creating a hardcopy check in view of check details of a virtual check.

### DETAILED DESCRIPTION

The figures illustrate an exemplary implementation of a methodology and system for cash handling and accountancy services. Based on the foregoing, it is to be generally understood that the nomenclature used herein is simply for convenience and the terms used to describe the invention should be given the broadest meaning by one of ordinary skill in the art.

I. System Overview

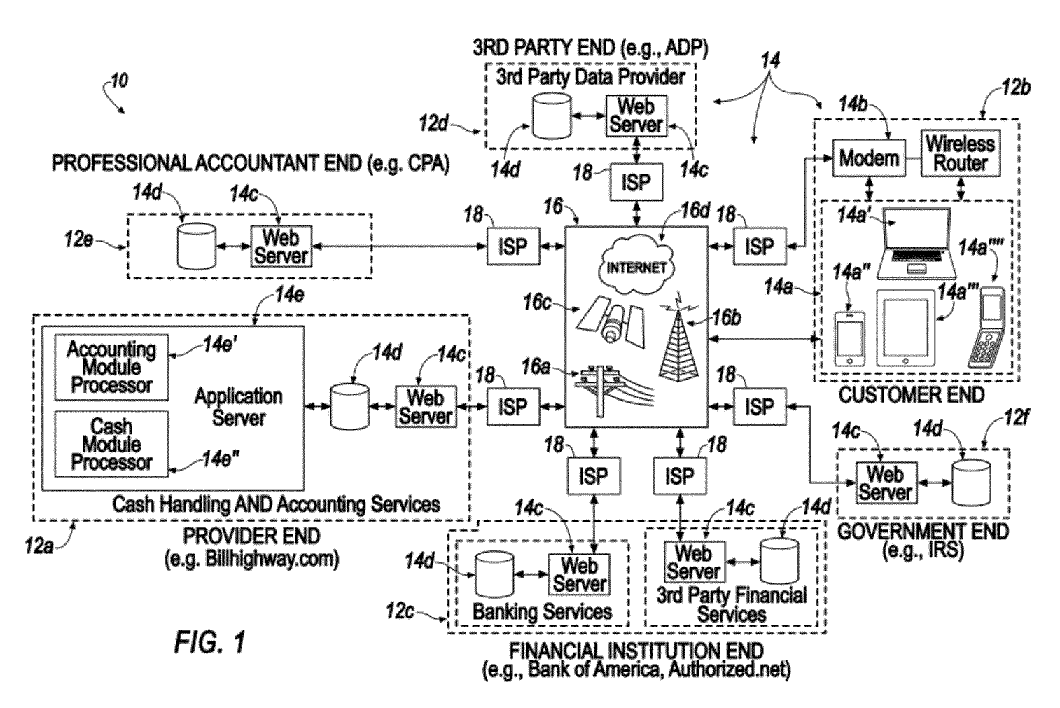

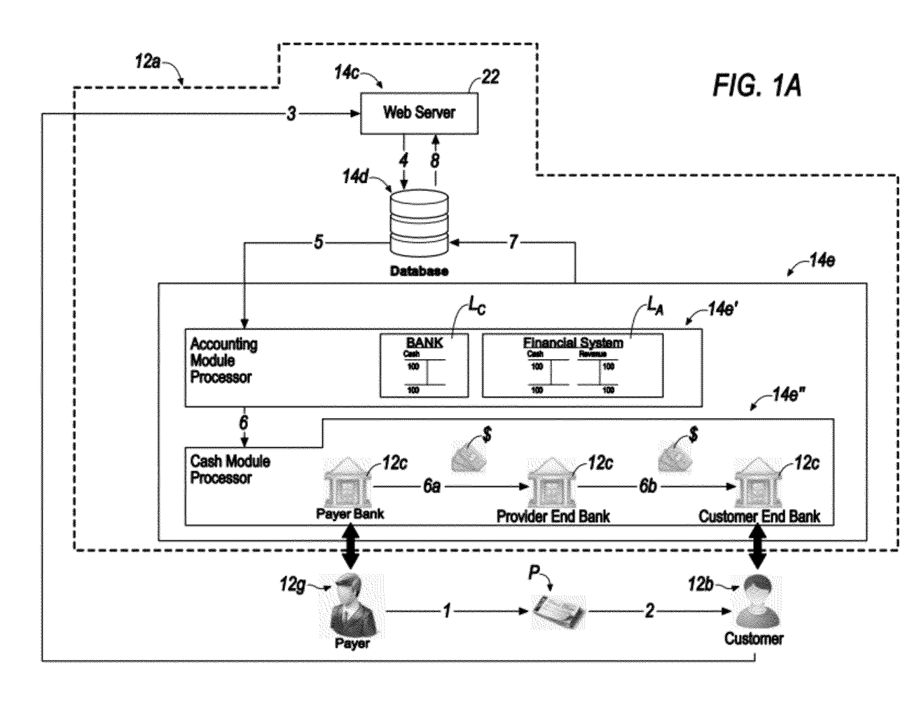

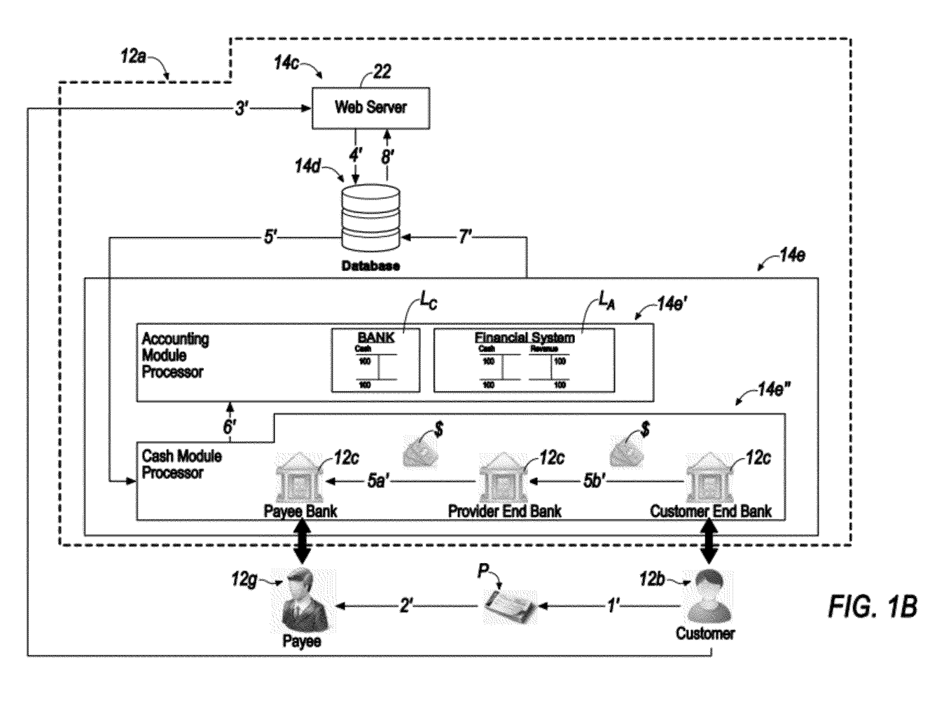

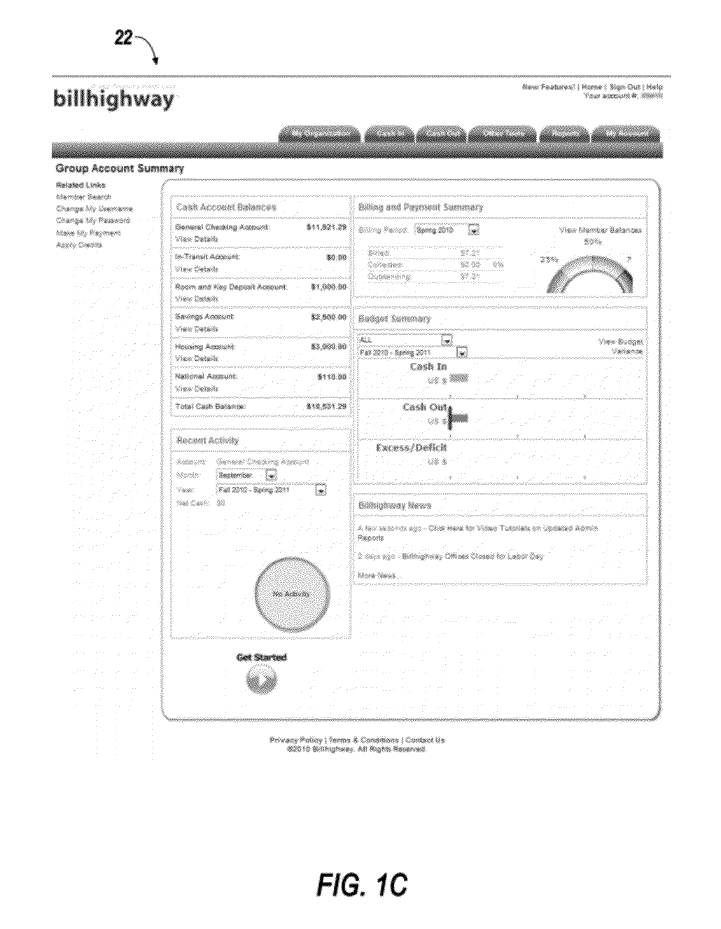

FIG. 1 illustrates an exemplary implementation of a system, which is shown generally at 10. The system 10 yields “virtual cash handling and accountancy services” provided from a provider end 12a (e.g., www.billhighway.com) that is/are consumed by one or more consumers at a customer end 12b.

The system 10 may further comprise additional ends 12c-12f that may communicate with one or more of the provider end 12a and the customer end 12b. The additional ends 12c-12f may include, but are not limited to: a financial institution end 12c (e.g., BANK OF AMERICA®, AUTHORIZE.NET®), a third party data provider end 12d (e.g., ADP®), a professional accountant end 12e (e.g., a Certified Public Accountant (CPA)) and a government end 12f (e.g., the Internal Revenue Service (IRS)) or the like. Although examples of the additional ends 12c-12f are described above, the system 10 is not limited to the above-identified additional ends 12c-12f, and, as such, other ends (e.g., a payer/payee end 12g as seen in FIGS. 1A, 1B) may be included in the system 10.

Communication of information to/from the ends 12a-12f of the system 10 may include, but is not limited to an electronic communication of entered or selected data. The entered or selected data may be stored on, processed by, manipulated by, modified by, sent from, received by, or otherwise transmitted by a plurality of interconnected components 14 of the system 10.

The plurality of interconnected components 14 may include but are not limited to: one or more computers 14a, one or more modems/wireless routers 14b, one or more web servers 14c, one or more databases 14d, one or more application servers 14e including one or more processors 14e′, 14e″, or the like. Although some of the plurality of interconnected components 14 are not shown at each end 12a-12f, it will be appreciated that some of the plurality of interconnected components 14 may be exclusive to a particular end 12a-12f, or, in the alternative, some of the plurality of interconnected components 14 may not be physically located in a similar location/building of a particular end 12a-12f and that some of the one or more computers 14a, the one or more modems/wireless routers 14b, the one or more web servers 14c, the one or more databases 14d and the one or more application servers 14e may be located remotely in a distributed fashion.

In an implementation, the one or more computers 14a include, but is/are not limited to: one or more computer workstations 14a′ (e.g., a desktop computer, a laptop computer or the like), one or more cell phones/smart-phones 14a″ (e.g., BLACKBERRY®, IPHONE® or the like), one or more tablet computers 14a′″ (e.g., IPAD® or the like) and/or one or more satellite phones 14a″″. In an implementation, each of the one or more computers 14a include a display that presents an image (such as, for example, a browser 20 including web-page content 22 as shown in, for example, FIGS. 1C, 4A-4D, 6A-6D and 8A-9C). Further, each of the one or more computers 14a include a human-interfacable means (e.g., a keyboard, mouse, touch-screen, microphone or the like) in order to permit, for example, a customer at the customer end 12b to enter/make selections/manipulate data associated with the image presented on the display of the one or more computers 14a. Although the one or more computers 14a are only shown at the customer end 12b in FIG. 1, it will be appreciated that one or more computers 14a may also be included at or otherwise associated with the provider end 12a, the financial institution end 12c, the third party data provider end 12d, the professional accountant end 12e, the government end 12f and the payer/payee end 12g (see, e.g., FIGS. 1A, 1B).

The ability of the ends 12a-12g to communicate with one another is enabled by one or more communication services/platforms 16. The one or more communication services/platforms 16 include but is/are not limited to: plain-old-telephone services (POTS) 16a, cellular services 16b, satellite services 16c, Internet access services 16d (including but not limited to: dial-up, landline [i.e., cable, optical fiber, twisted pairs], T-lines, Wi-Fi, cell phone), or, a hybrid/combination of two or more of the POTS 16a, cellular services 16b, satellite services 16c and Internet services 16d.

If, for example, access to Internet services 16d is requested during the operation of the system 10, the system 10 may be said to further include or otherwise cooperate with one or more Internet service providers (ISP) 18 that is/are connected to or otherwise in communication with the plurality of interconnected components 14. In an implementation, the one or more computers 14a of the plurality of interconnected components 14 may launch/utilize a browser 20 (e.g., INTERNET EXPLORER®, SAFARI®) as shown, for example, in FIGS. 1C, 4A-4D, 6A-6D and 8A-9C, that accesses and displays web-page content 22 (see also FIGS. 1C, 4A-4D, 6A-6D and 8A-9C) on the display of the one or more computers 14a.

The web-page content 22 may be provided by the provider end 12a and enables the use of the “virtual cash handling and accountancy services” that may be consumed by a consumer at the customer end 12b. The logic and operation of the web-page content 22 is stored on/executed by/controlled by one or more of the web server 14c, database 14d and application server 14e at the provider end 12a. In an implementation, the customer at the customer end 12b may utilize a keyboard, mouse, touch-screen, microphone or the like of the one or more computers 14a in order to permit the customer at the customer end 12b to enter/make selections/manipulate data associated with the web-page content 22 presented on the display of the one or more computers 14a in order to permit the customer at the customer end 12b to utilize the “virtual cash handling and accountancy services.”

In an implementation, the word “virtual” in the context of “virtual cash handling and accountancy services” may mean, but is not limited to being defined as: “being conducted on or simulated on a computer.” Accordingly, in an implementation, a consumer at the customer end 12b may utilize the one or more computers 14a to manipulate, modify, send, receive, or otherwise transmit information electronically to other ends 12a, 12c-12f of the system in order to utilize/consume the “virtual cash handling and accountancy services” provided by the provider end 12a. In another implementation, the word “virtual” in the context of “virtual cash handling and accountancy services” may mean, but is not limited to being defined as: “occurring or existing online via the Internet.”

Further, although an implementation of the system 10 may be said to be simulated on a computer 14a, and/or occurring or existing online via the Internet, operation of the system 10 may also be complemented by, for example, one or more living/live persons in/directly associated with the provider end 12a. The one or more living/live persons in/directly associated with the provider end 12a may assist (by way of, e.g., POTS, voice-over-Internet Protocol (VoIP)/chat point-to-point protocol (PPP)) one or more consumers at the customer end 12b that consume the virtual cash handling and accountancy services provided by the provider end 12a. It should be understood, however, that the one or more living/live persons in/directly associated with the provider end 12a are limited to, for example, providing “help desk services” or “trouble-shooting related services” pertaining to, for example, an issue related to the web-page content 22 and do not provide any form of cash handling or accounting services.

In an implementation, the phrase “cash handling” in the context of “virtual cash handling and accountancy services” may mean, but is not limited to being defined as: “electronically automated tracking an amount of funds available within a cash account.” The electronic automated tracking of the amount of funds may include but is not limited to the provider end 12a utilizing the cash module sub-processor 14e″ to track one or more of (a) real-time credit(s) and (a) real-time debit(s) applied to a sum of cash within a cash account at, for example, the financial institution end 12c. In an implementation, the “cash handling” function enacted by the cash module sub-processor 14e″ is said to operate outside of the scope of traditional “online banking services” provided by the financial institution end 12c to the customer at the customer end 12b such that, in an implementation, the provider end 12b interfaces with or otherwise “taps into” a database 14d at the financial institution end 12c and in order to track and execute/authorize transaction activity of the cash account at the financial institution end 12c for the purpose of providing the “virtual cash handling and accountancy services.”

In an implementation, the word “accountancy” in the context of “virtual cash handling and accountancy services” may mean, but is not limited to being defined as: “a system of electronically automated recording and summarizing business and financial transactions for analyzing, verifying and reporting the results.” Further, “accountancy” in the context of “virtual cash handling and accountancy services” may include one or more of the following accounting concepts conducted in an electronically automated fashion: bookkeeping, trial balance, general ledger, debits and credits, costs of goods sold, double-entry system, standard practices, and cash and accrual balances.

In an implementation, the “accountancy” function of the “virtual cash handling and accountancy services” may be controlled by an accounting sub-processor 14e′. The accounting sub-processor 14e′ may include proprietary automated accounting intelligence (AAI) in order to provide the customer end 12b with a “virtual accountant” in view of, for example, the cash activity associated with transactions from a cash account associated with the financial institution end 12c. Accordingly, “Accountancy” as implemented by the AAI in the context of “virtual cash handling and accountancy services” may be conducted in an electronically automated fashion by the “virtual accountant” in view of the Generally Accepted Accounting Principles (GAAP). The GAAP includes standards, conventions and rules followed by professional accountants in the recording and summarization of transactions and in the preparation of financial statements. Alternatively, or, in addition to the GAAP, “accountancy” as practiced in the context of “virtual cash handling and accountancy services” may be conducted in an electronically automated fashion in view of the International Financial Reporting Standards (IFRS) adopted by the International Accounting Standards Board (IASB). Although the GAAP and the IFRS have been mentioned above, it will be appreciated that “accountancy” as practiced in the context of “virtual cash handling and accountancy services” may be conducted in an electronically automated fashion in view other standards/conventions/practices not mentioned here.

Referring to FIG. 1A, a general overview of an implementation of the system 10 is described in a flow diagram including steps 1-through-8. According to an embodiment, the steps 1-through-8 of FIG. 1A describes an exemplary “deposit”/“incoming funds” embodiment of the system 10 when a payer at a payer end 12g makes a payment, P, to a customer at the customer end 12b such that the customer at the customer end 12b may subsequently act upon the payment, P, and utilize the system 10 to record, in tandem, the payment, P, as a deposit at the provider end 12a and as a cash transaction for physically/electronically moving funds from one financial institution 12c (or account) to another financial institution 12c (or account).

Initially (see step 1), a payer at the payer end 12g sends a payment amount (e.g., which may be designated upon the payment, P, in the form of an amount written on a check) that is later received (see step 2) by a customer (i.e., a payee) at the customer end 12b. Then (see step 3), the customer at the customer end 12b accesses the web-page content 22 from the web server 14c at the provider end 12a and enters payment data (including, e.g., the payment amount, a payer financial institution routing number, a payer checking account number, and the like). In an implementation, the customer at the customer end 12a types-in the payment amount such that the web-page content 22 is manipulated to display the payment amount; then, the payment amount is received (see step 4) by the provider at the provider end 12a in response to, for example, the customer at the customer end 12a clicking on an enter button included in the web-page content 22. Afterward, data associated with the entered payment amount is recorded within the database 14d at the provider end 12a.

Subsequently, the recorded payment amount within the database 14d at the provider end 12a is sent to or retrieved by (see step 5) the application server 14e at the provider end 12a for further processing by the accounting module processor 14e′ (that is programmed with the AAI) at the provider end 12a in order to create an accounting journal entry that is written to a general accounting ledger, L_{A}, that will later contribute to a financial statement displayed as web-page content 22 (see FIG. 1C) at the customer end 12a. The information (e.g., the accounting journal entry, the general accounting ledger, L_{A}, the financial statement or the like) arising from the processing conducted by the accounting module processor 14e′ is later stored on the database 14d at the provider end 12a (see step 7).

When the accounting journal entry is created (see step 5), the accounting module processor 14e′ of the provider end 12a creates, in tandem, a cash handling journal entry (as a deposit) in order to reflect a real-time, true cash ledger, L_{C}, in order to permit the provider end 12a to record and report, in real-time, a checking/savings available account balance for the customer at the customer end 12b on the basis of previously known account balance(s) that was previously provided to the provider end 12a (i.e., the previously-known amount in the account+the recently-entered deposit). The information (e.g., the real-time, true cash ledger, L_{C}) arising from the processing conducted by the cash module processor 14e″ is later stored on the database 14d at the provider end 12a (see step 7). As a result, the customer at the customer end 12b does not have to physically deposit the payment, P, at a brick-and-motor financial institution 12c nor would the customer at the customer end 12b need to access a website associated with the brick-and-mortar financial institution 12c in order to view their checking/saving available account balance because the available account balance is stored as a cash handling journal entry in the database 14d at the provider end 12a in tandem with accounting information from the accounting journal entry.

Although, at step 5, the recording of the payment in the form of a deposit is completed within the accounts receivable ledger, L_{A}, and in the real-time, true cash ledger, L_{C}, a physical (or electronic) movement of funds from the payer's financial institution 12c to the provider end financial institution 12c remains to be settled. Accordingly, in response to the AAI executed by the accounting module processor 14e′ described above with respect to the accounts receivable ledger, L_{A}, and true cash ledger, L_{C}, entries and calculations (see step 6), the provider 12a communicates with one or more of the financial institution ends 12c in order to permit the cash module processor 14e″ of the provider end 12a to open (see step 6a) a communication interface (by way of, e.g., the one or more communication services/platforms 16 of FIG. 1) between the payer's financial institution 12c and the provider end's financial institution 12c in order to communicate, for example, the entered payment data (including, e.g., the payment amount, the payer financial institution routing number, the payer checking account number, and the like) as well as provider end financial institution routing number and provider end checking account number from the provider end 12a to the payer's financial institution end 12c in order to execute a transaction of a physical/electronic movement of cash funds, $, from, for example, the payer's financial institution checking account to, for example, the provider end's financial institution checking account. Then, the provider end financial institution 12c may subsequently transfer the cash funds, $ (see step 6b), to the customer end financial institution 12c. Thus, as a result, it may be said that the system 10 results in the provider end 12a not only providing accounting services, but, also, in response to the accounting services conducted by the AAI (see step 6), the system 10 also functions as a cash broker that moves cash funds, $ (see steps 6a, 6b), from (1) the payer financial institution 12c (or account) to (2) the provider end financial institution 12c (or account) and to (3) the customer end financial institution 12c (or account); the end result is that the available amount of physical cash funds, $, is always reconciled with accounting information (e.g., a financial statement/balance sheet), which is both viewable in consolidated form by the customer at the customer end 12b as web page content 22 (see step 3) that is populated with data that was provided (see step 8) from the database 14d. Further, the customer at the customer end 12b may also access (see step 3) web page content 22 (see FIG. 1C) in order to view a report including a combination of cash handing and accounting entries that may include or arise from, for example, the past history of accounting journal entries, the past history of cash handling journal entries, the general accounting ledger, L_{A}, the real-time true cash ledger, L_{C}, and the like. Thus, the system 10 alleviates, streamlines or otherwise flattens an accounting department's duties at the customer end 12b by utilizing the services rendered by the provider end 12a in order to permit the provider end 12a to manage the customer end's real-time cash in a financial institution with the customer end's amount of cash on a balance sheet in one system.

Referring to FIG. 1B, a general overview of an implementation of the system 10 is described in a flow diagram including steps 1′-through-8′. According to an embodiment, the steps 1′-through-8′ of FIG. 1B describes an exemplary “withdrawal”/“outgoing funds” embodiment of the system 10 when a customer at the customer end 12b makes a payment, P, to a payee at the payee end 12g such that the customer at the customer end 12b may subsequently act upon the payment, P, and utilize the system 10 to record, in tandem, the payment, P, as a withdrawal at the provider end 12a and as a cash transaction for physically/electronically moving funds from one financial institution 12c (or account) to another financial institution 12c (or account).

Comparatively, FIG. 1B is substantially similar to FIG. 1A with one exception. As seen in FIG. 1B, the entered and saved withdrawal by the customer at the customer end 12b results in the database 14d at the provider end 12a communicating (see step 5′) firstly with the cash module processor 14e″ (rather than communicating first with the accounting module processor 14e′ at step 5 in FIG. 1A) in order to execute a physical/electronic movement of cash funds, $, from the customer end financial institution 12c to the provider end financial institution 12c (see step 5b′) and thereafter from the provider end financial institution 12c to the payee end financial institution 12c (see step 5a′). Then, responsive to the physical/electronic movement of funds, the AAI of the accounting module processor 14e′ is actuated (see step 6′); thereafter, the database is reconciled (see step 7′) in order to reflect the cash handling and accountancy-related event. Afterward, the customer at the customer end 12b may access (see step 3′) and view web page content 22 from the web server 14c of the provider end 12a that reflects the withdrawal of cash funds. $, from the customer end financial institution 12c (or account) that was sent to the provider end financial institution 12c, which was then subsequently transferred to the payee end financial institution 12c.

II. Customer End Set-Up

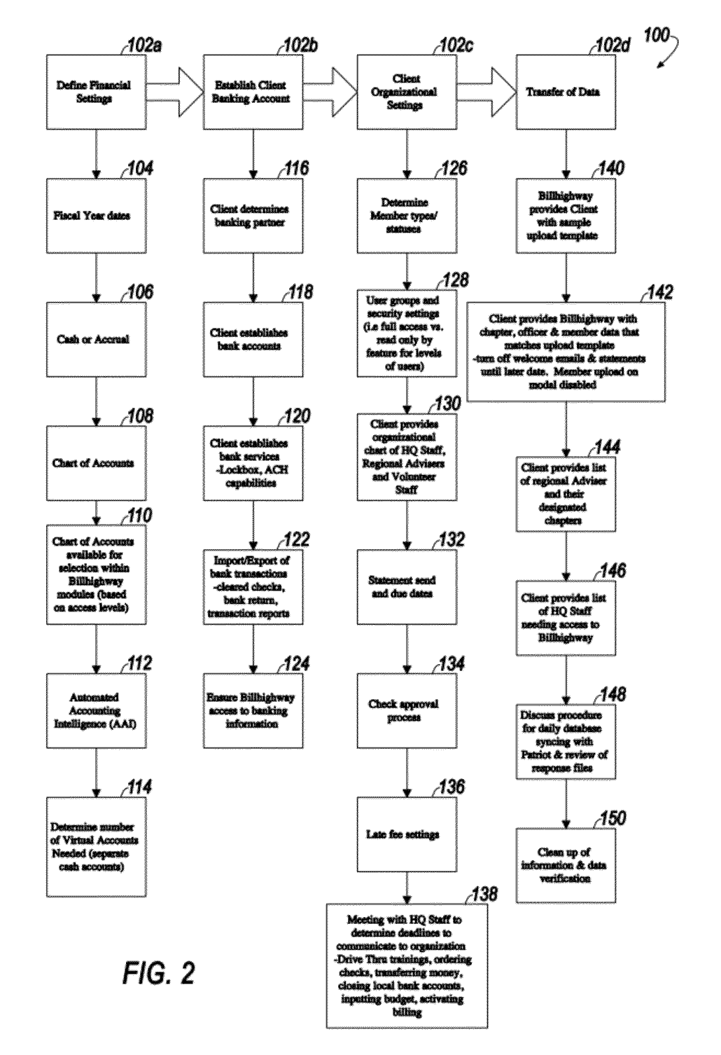

Prior to a customer at the customer end 12b subscribing to and utilizing the “virtual cash handling and accountancy services” provided by the provider end 12a, a method 100 in FIG. 2 for initializing the customer end 12b with the provider end 12a is shown and described according to an implementation. According to an implementation, the method 100 includes several steps 102a-102d with each step 102a-102d having a plurality of sub-steps 104-114, 116-124, 126-138 and 140-150.

A first step 102a of the method 100 is generally referred to as “defining financial settings” and includes sub-steps 104-114. The defining financial settings step 102a permits the customer at the customer end 12b to provide the provider end 12a with a financial perspective such that the provider end 12a may understand how the customer at the customer end 12b is structured (e.g., from a chart of accounts perspective). In an implementation, it may be said that step 102a lays the foundation of the “virtual accounting aspect” of the system 10 as it pertains to the customer at the customer end 12b. In an implementation, information/data provided by the customer at step 102a may be recorded on the database 14d at the provider end 12a.

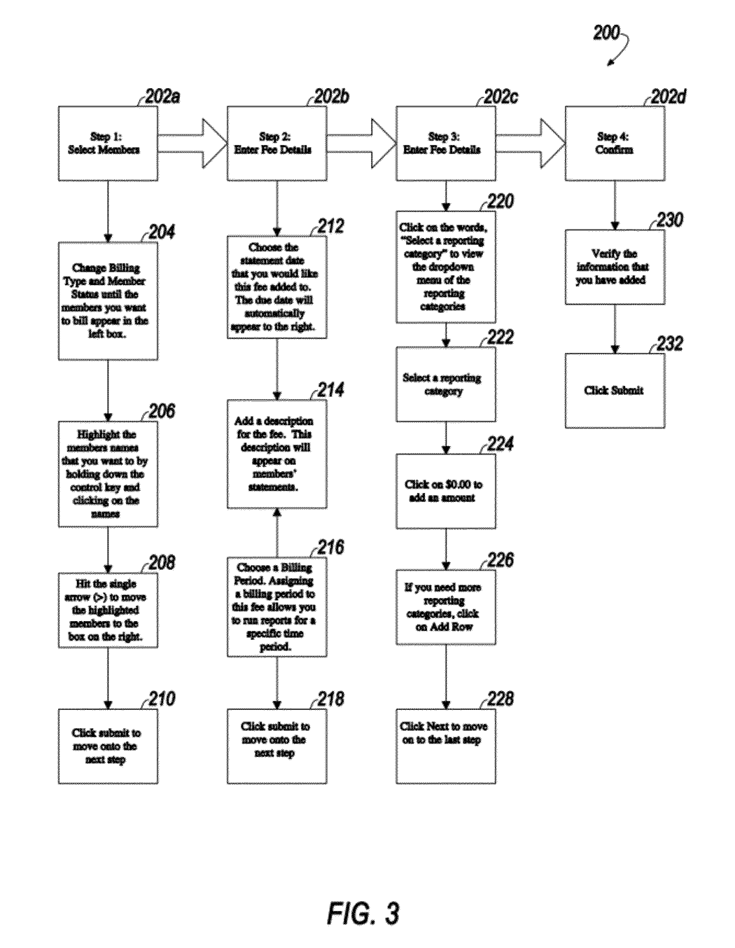

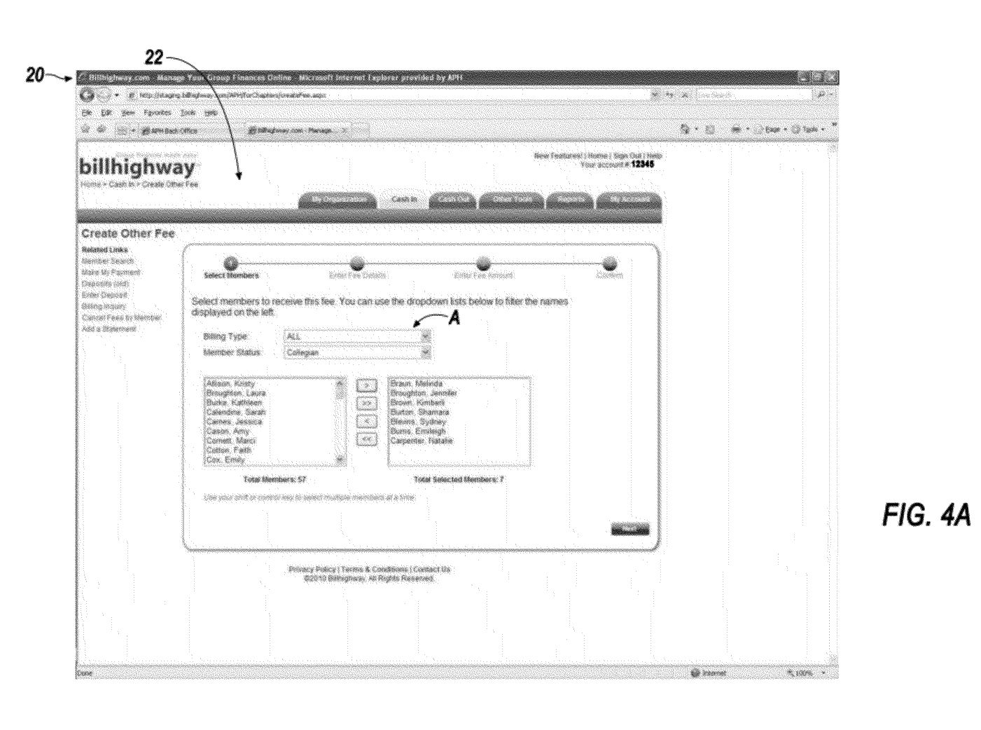

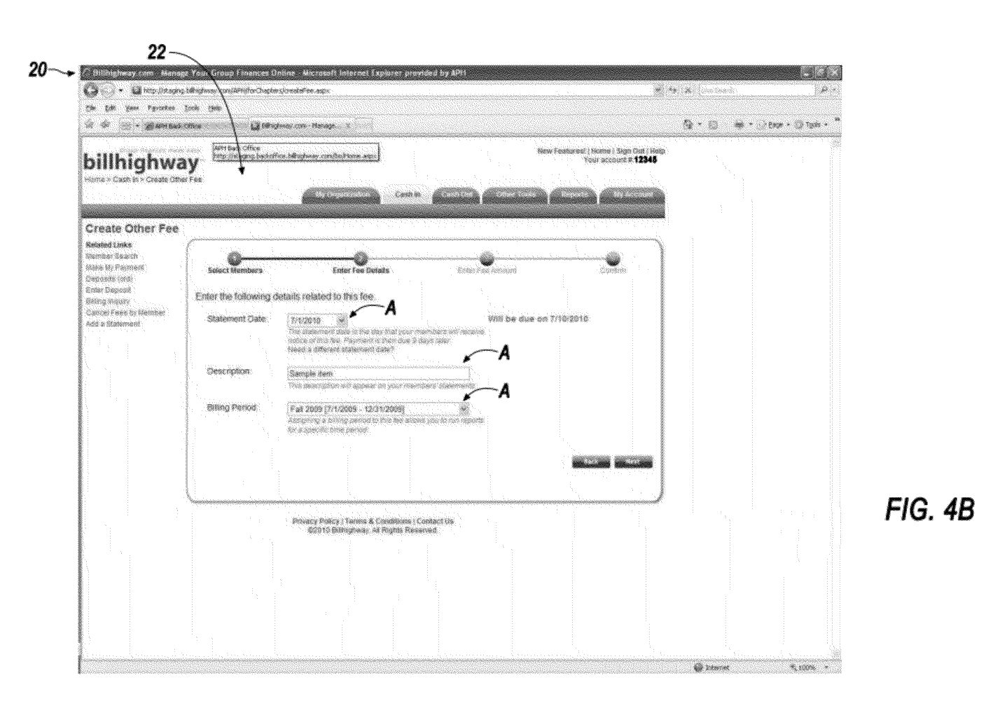

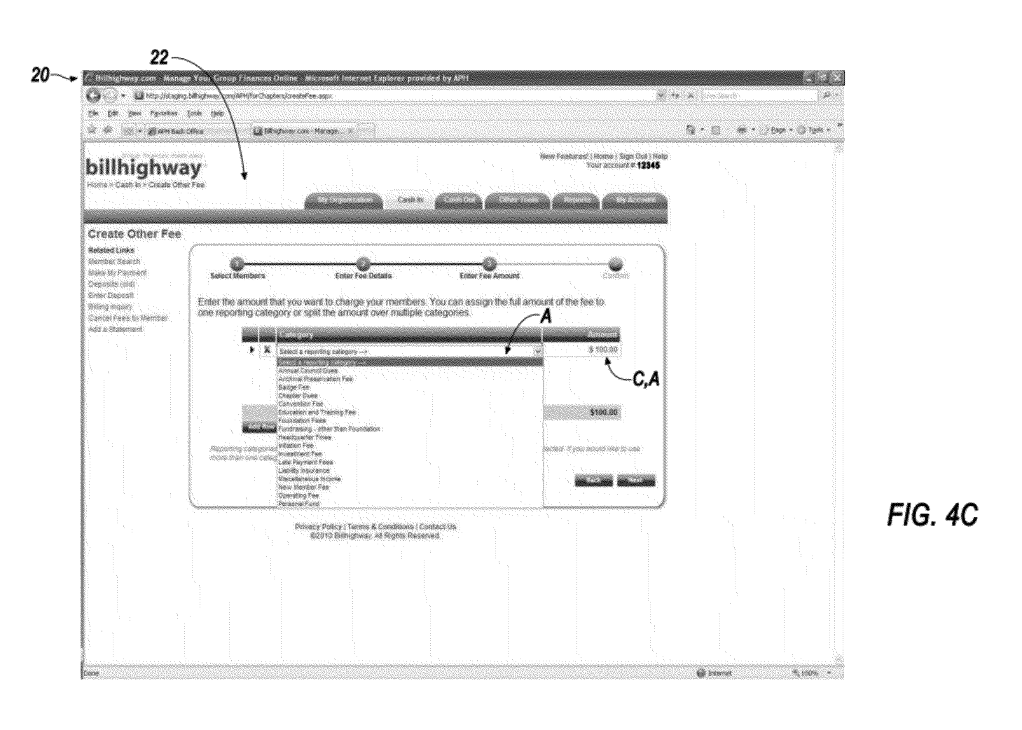

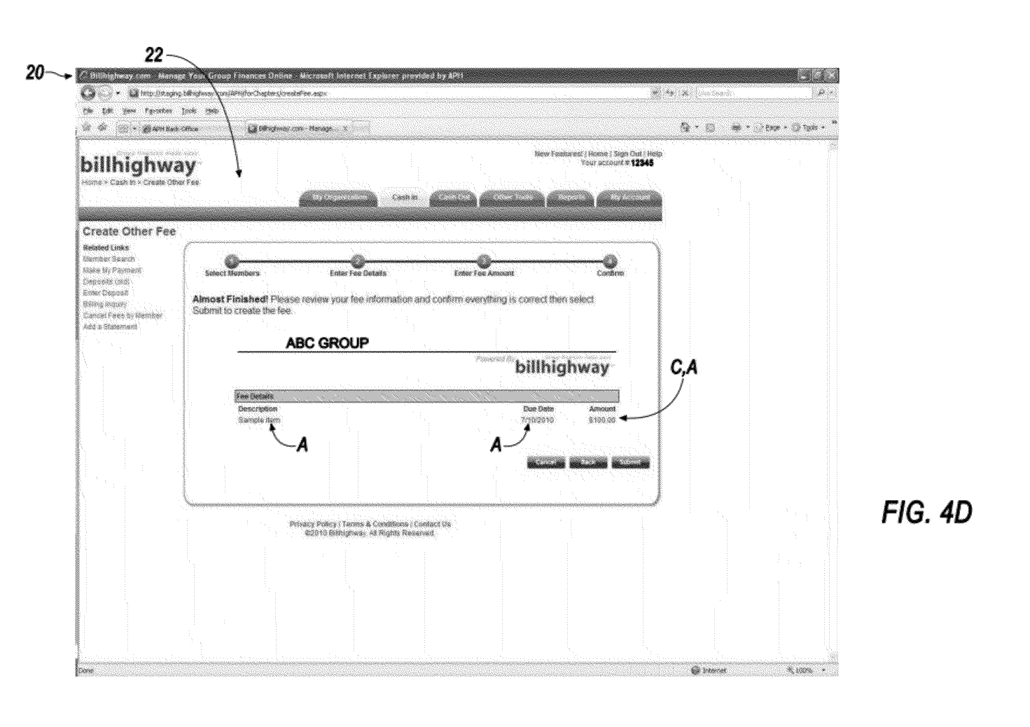

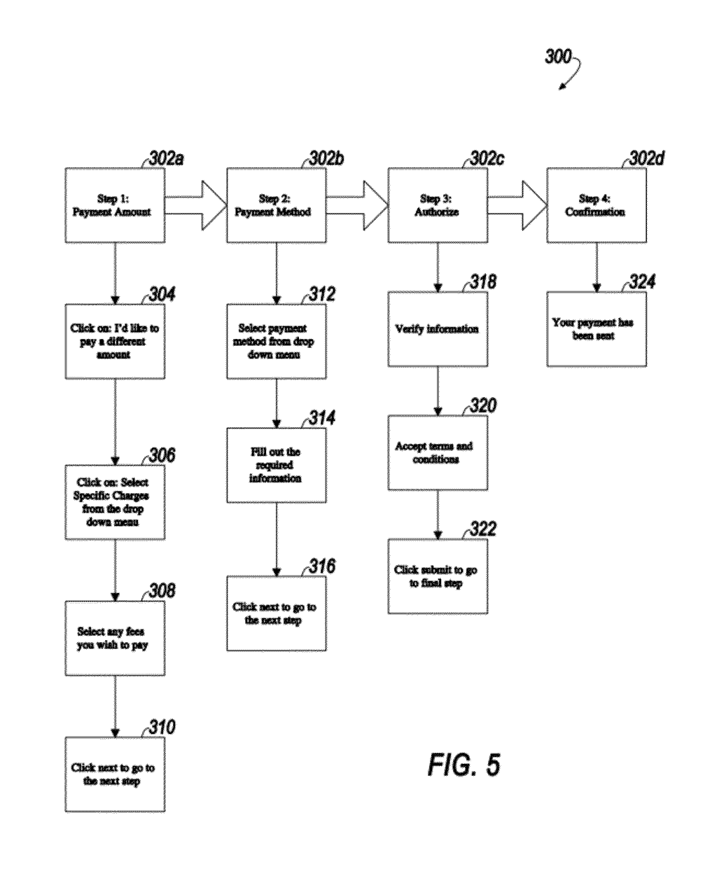

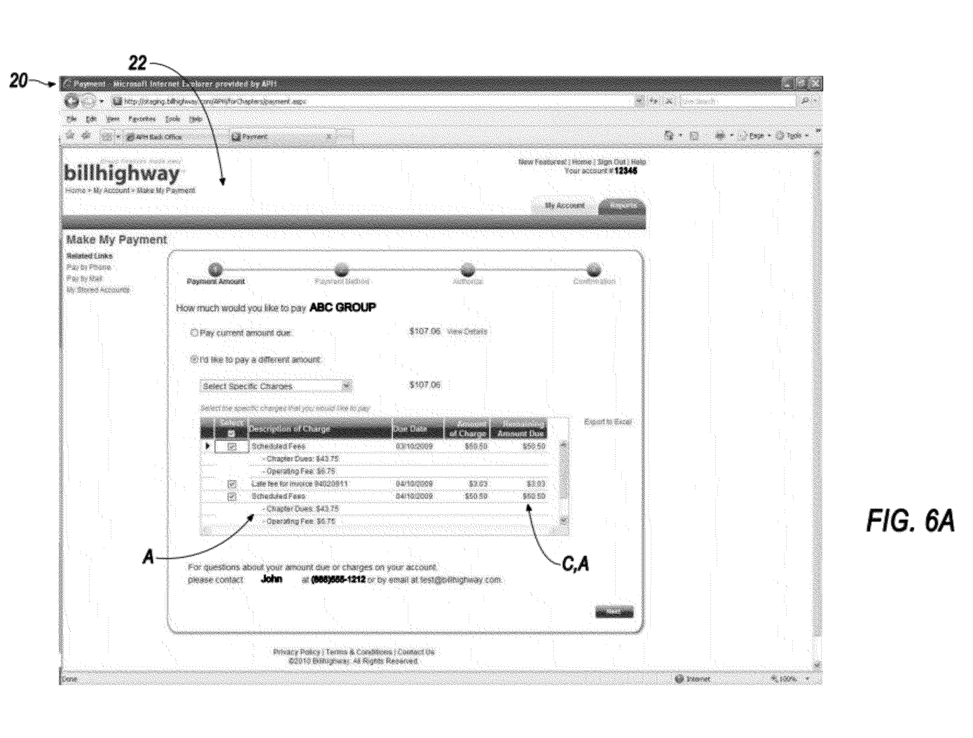

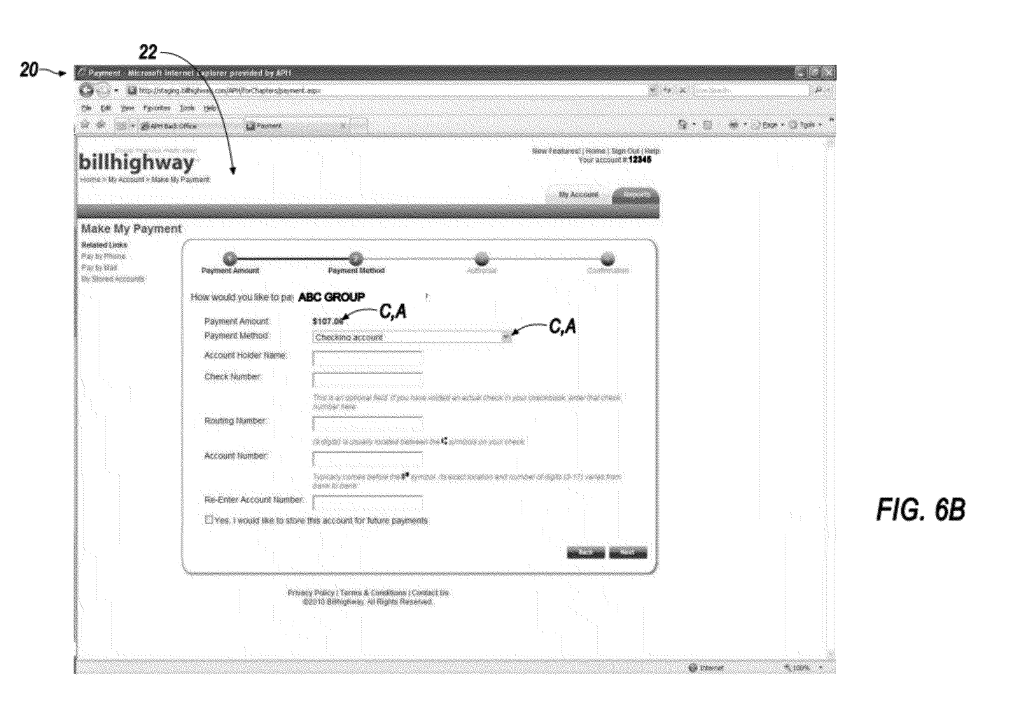

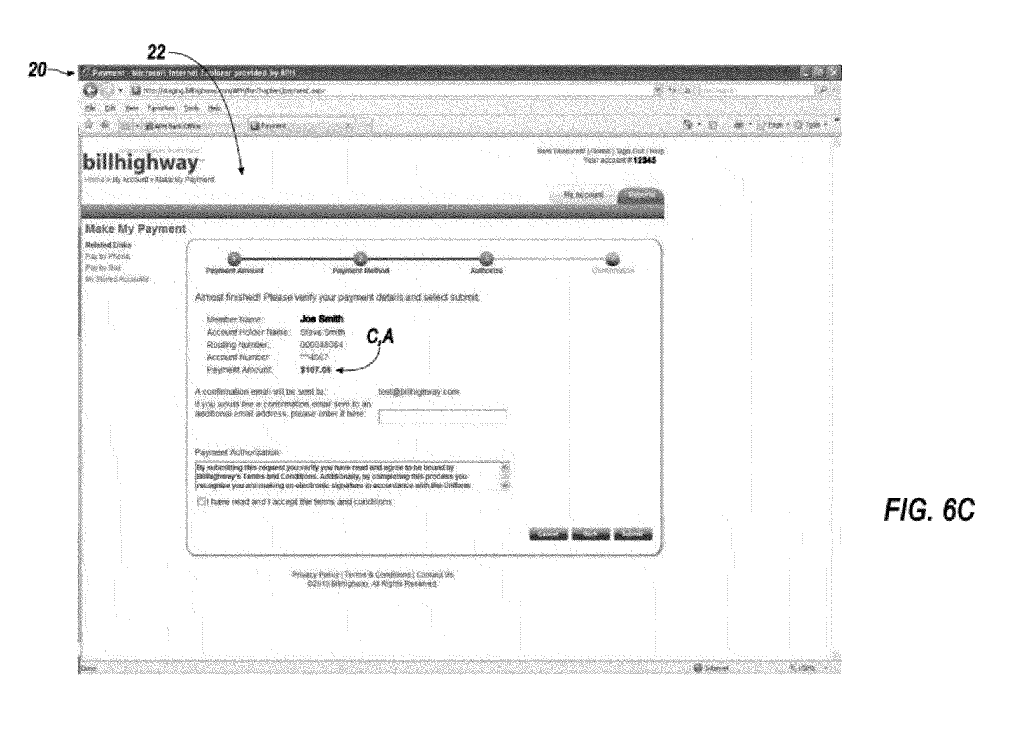

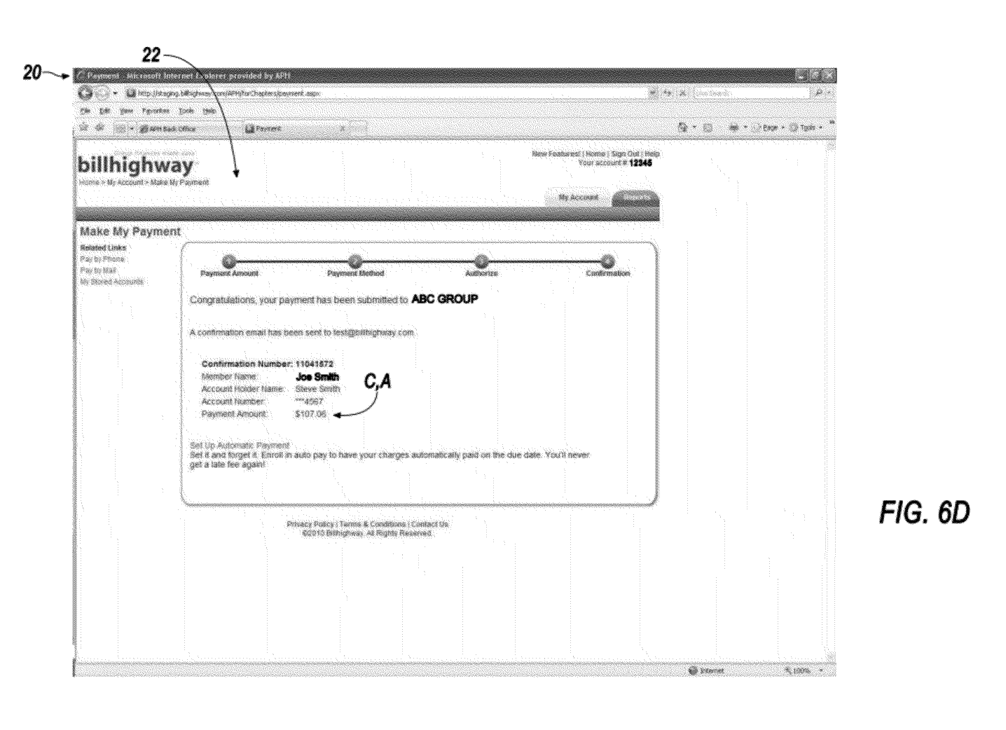

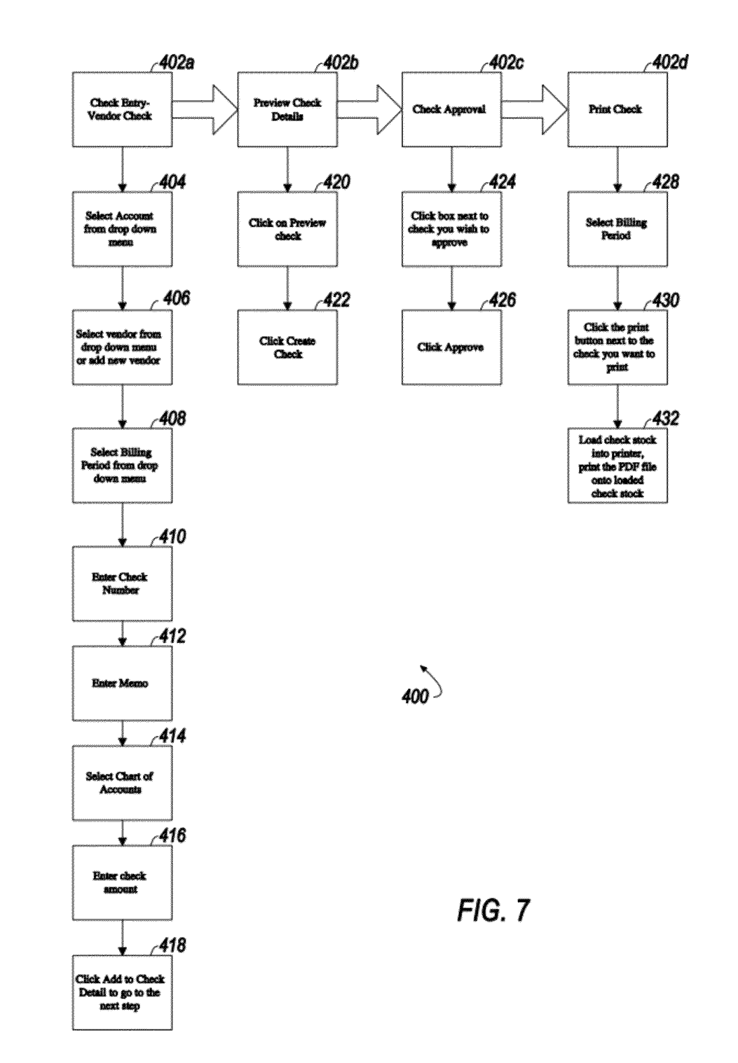

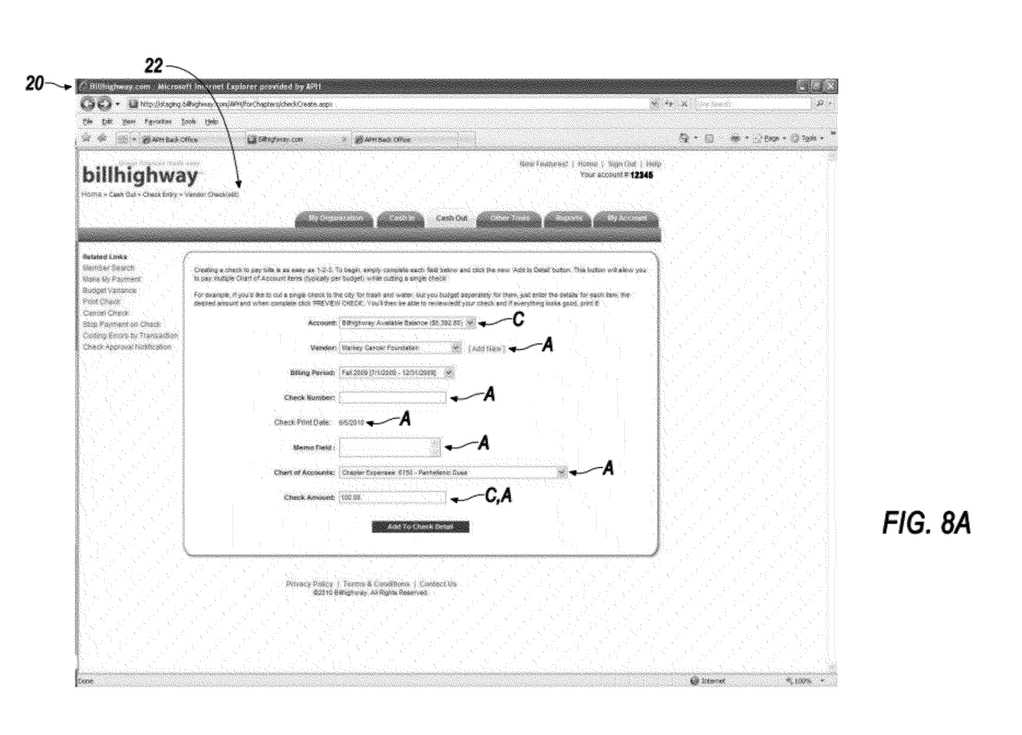

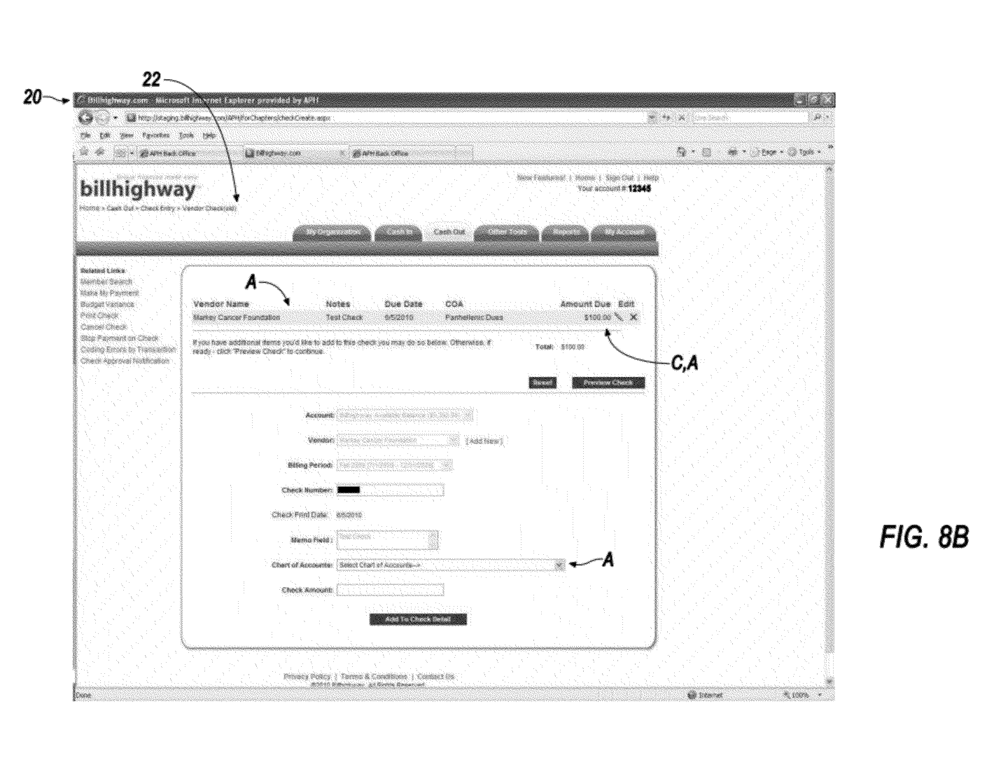

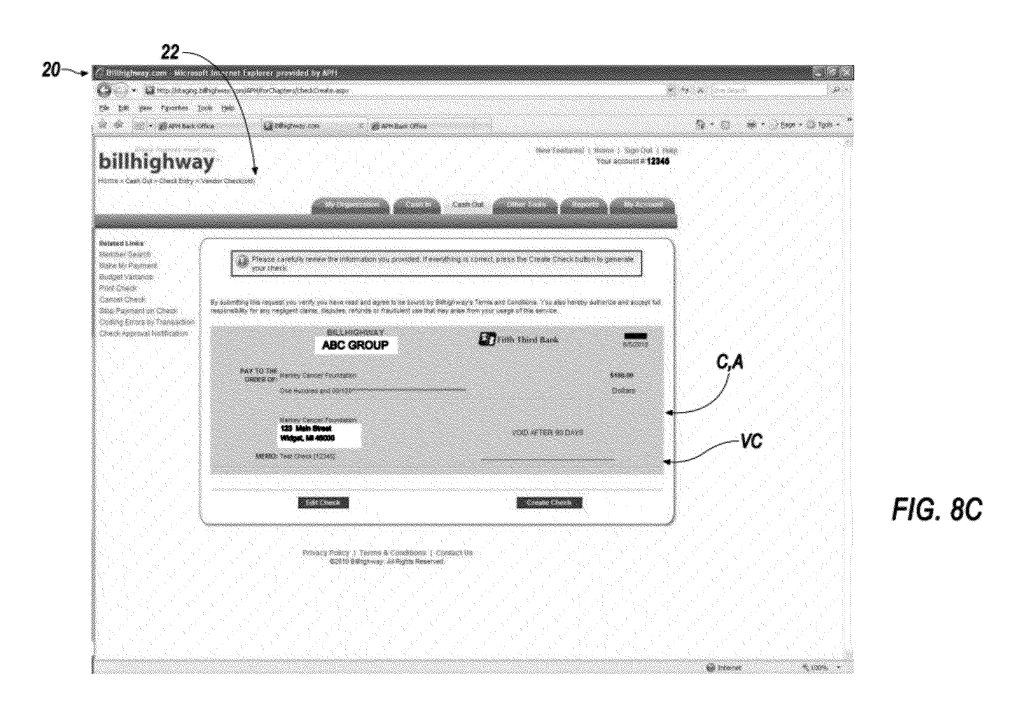

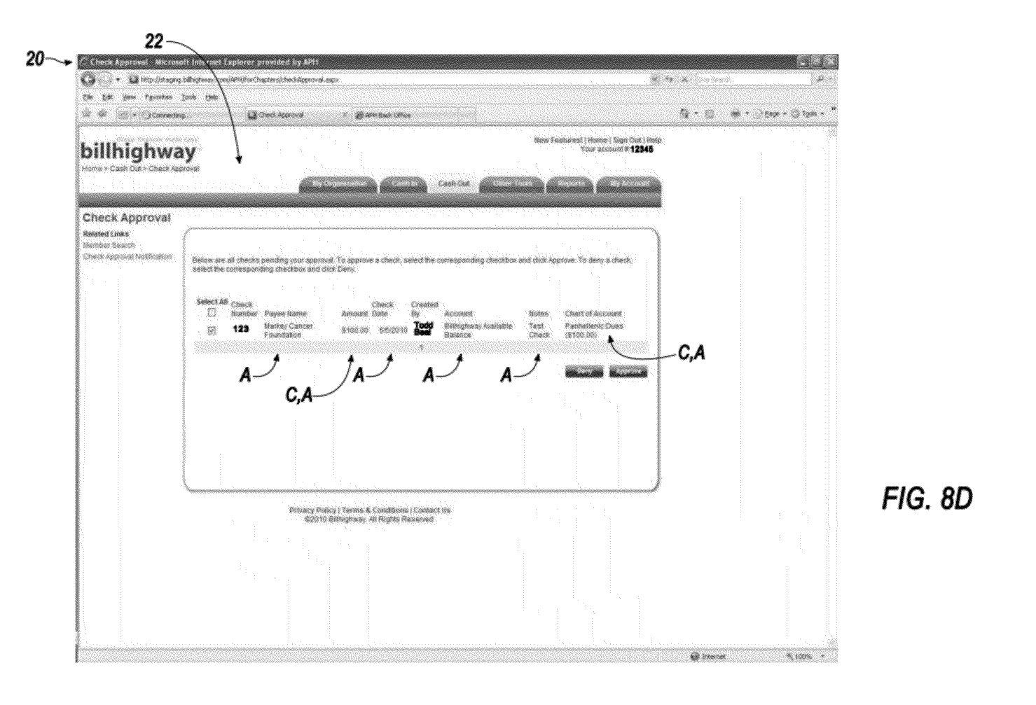

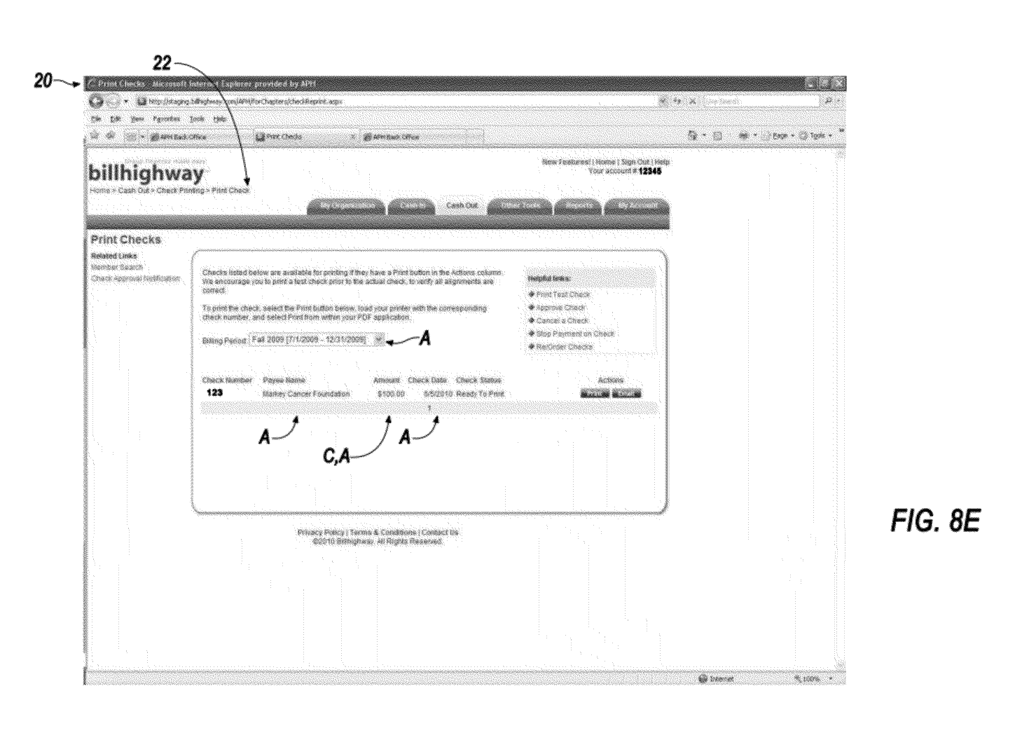

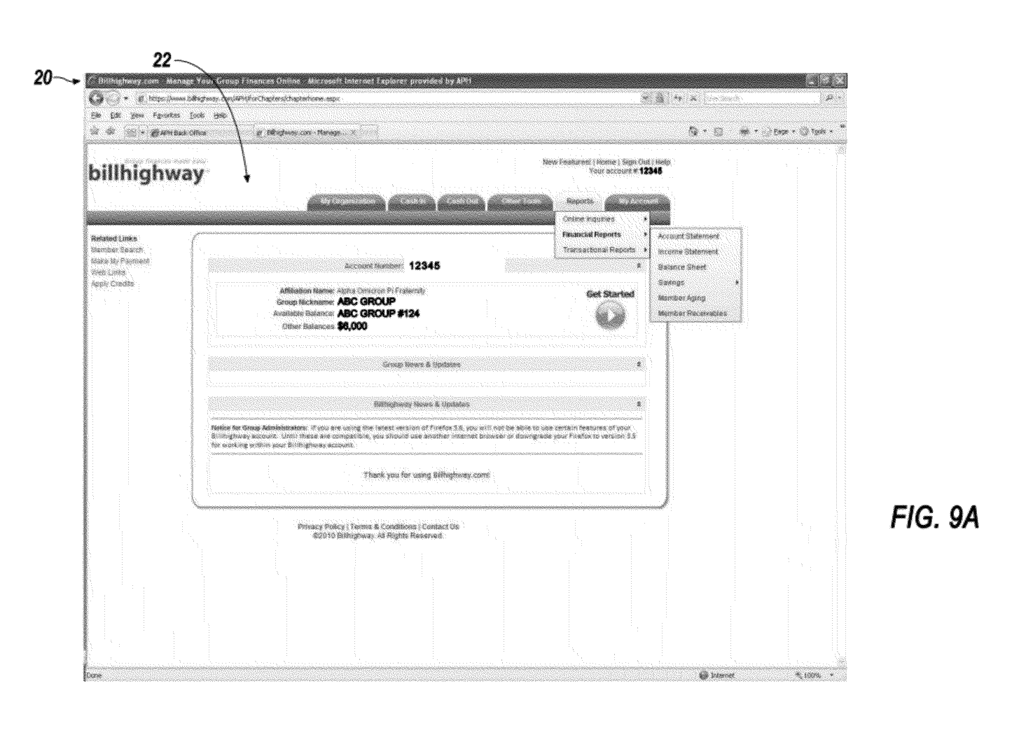

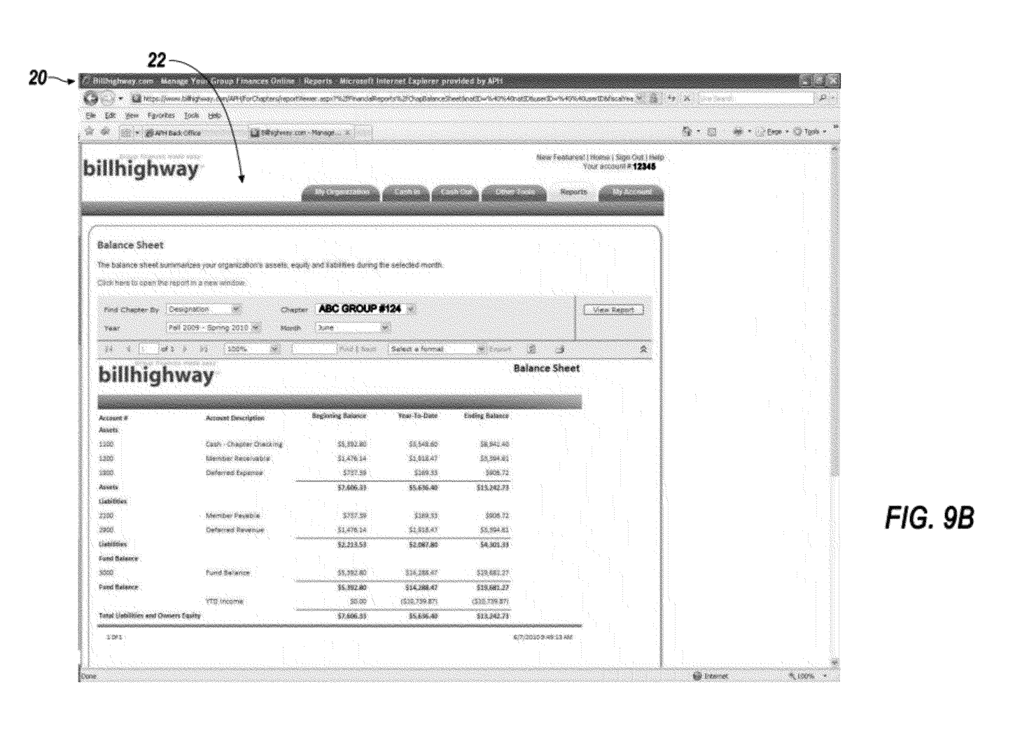

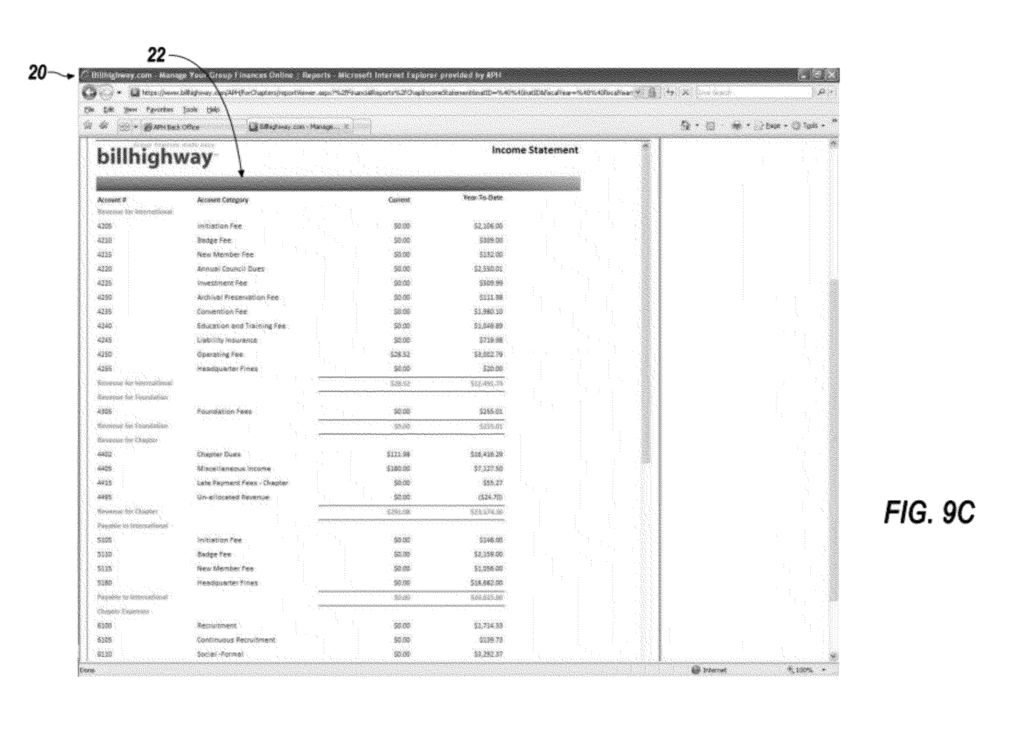

In an implementation, the defining financial settings step 102a includes sub-step 104 for defining a fiscal year of dates (i.e., a twelve month financial reporting period that the customer end 12b would like to establish, or, has established with the IRS). Further, sub-step 104 may also include importing previous fiscal year data into the provider end 12a from the customer end 12b such that the provider end 12a may obtain a frame of reference as to the most recent financial standing of the customer at the customer end 12b. In an example, the customer at the customer end 12b would provide to the provider end 12a with the fiscal year data before the customer at the customer end utilizes the virtual cash handling and accountancy services provided by the provider end 12a. The previous fiscal year data may then be provided from, for example, the database 14d at the provider end 12a to a virtual general accounting ledger, L_{A} (see FIGS. 1A, 1B), at the provider end 12a such that the customer at the customer end 12b may begin their new fiscal year activities while having access to all of the most recent year end activity as expressed in the form of assets, liabilities, equity and the like. Going forward with use of virtual cash handling and accountancy services, the changes to the customer's virtual balance sheet (see, e.g., FIG. 9B) will be tracked and dynamically updated by the provider end 12a when, for example, bills are sent (see, e.g., FIGS. 3-4D), funds are collected (see, e.g., FIGS. 5-6D) and money is spent (see, e.g., FIGS. 7-8D).

In an implementation, the defining financial settings step 102a further includes customer end 12b informing the provider end 12a with a selection of one of a cash method of accounting or an accrual method of accounting at sub-step 106. Cash or accrual methods of accounting are provided as a basis for reporting to the IRS.

In an implementation, the defining financial settings step 102a further includes defining a chart of accounts at sub-step 108. The defining chart of accounts sub-step 108 includes defining account categories that the customer at the customer end 12b uses for financial statements as well as reports to be generated (e.g., revenue accounts, expense accounts, liability accounts and the like as well as account categories are within each account).

In an implementation, the defining financial settings step 102a further includes defining accessibility to the chart of accounts at sub-step 110. In an implementation, at sub-step 110, the customer end 12b may inform the provider end 12a with access rights limitations in order to limit access to the chart of accounts information from the provider end 12a at the customer end 12b.

In an implementation, the defining financial settings step 102a further includes the customer at the customer end 12b providing one or more AAI data inputs to the provider end 12a at sub-step 112. For example, in an embodiment, the customer at the customer end 12b may inform the provider end 12a at sub-step 112 which account from the chart of accounts to debit or credit based upon a particular transaction type (e.g., if a payer makes a payment, the provided AAI data input will result in the AAI knowing to debit a cash payment as a receivable).

In an implementation, the defining financial settings step 102a further includes defining a number of virtual cash accounts to be utilized at sub-step 114. In an example, at sub-step 114, the customer at the customer end 12b may create identifiable names for one or more cash accounts in order to clearly identify a purpose for each cash account (e.g., “Building Repair Fund,” “Deposits” or the like).

A second step 102b of the method 100 is generally referred to as “establishing banking account information” and includes sub-steps 116-124. The establishing banking account information step 102b permits the customer at the customer end 12b to provide the provider end 12a with a banking perspective such that the provider end 12a may understand which and how many financial institutions at, for example, the financial institution end 12c that the customer at the customer end 12b utilizes. In an implementation, it may be said that step 102b lays the foundation of the “virtual cash management aspect” of the system 10 as it pertains to the customer at the customer end 12b.

In an implementation, the sub-step 116 includes the customer at the customer end 12b determining which banking partner(s) at the financial institution end 12c should be utilized. Then, sub-step 118 includes the customer at the customer end 12b sets up (an) account(s) with (a) banking partner(s) at the financial institution end 12c. Then, sub-step 120 includes the customer at the customer end 12b establishing banking services (e.g., lockbox, ACH capabilities) that are to be provided by the banking partner(s) at the financial institution end 12c in order to permit the services provided by the provider end to “reside on top of” the services provided by the financial institution end 12c. Then, sub-step 122 includes the provider end 12a accepting and feeding data in real time with the financial institution end 12c.

At sub-step 124, the customer at the customer end 12b permits the provider end 12a to have access to the customer's banking information related to the selected banking partner(s) from sub-step 116. As will be explained in the foregoing disclosure, access to the customer's banking information related to the banking partner(s) at the financial institution end 12c permits the provider end 12a to know, from an operating perspective, how the customer at the customer end 12b utilizes/moves cash such that the provider end 12a may be authorized to electronically execute a transaction by moving cash into/out from the financial institution end 12c on behalf instructions electronically sent from the customer at the customer end 12b to the provider at the provider end 12a (by way of, e.g., the web-page content 22) all while the provider at the provider end 12a electronically accounts, in an automated fashion (with, e.g., the AAI of the accounting module sub-processor 14e′), for all of the customer's financial activity from a true financial perspective (e.g., a general ledger accounting perspective including debit and credit entries into the client's general accounting ledger, L_{A}).

A third step 102c of the method 100 is generally referred to as “electronically providing setting preferences from the customer end 12b to the provider end 12a” and includes sub-steps 126-138. In an implementation, the electronically providing setting preferences from the customer end 12b to the provider end 12a at step 102c may include organizational-specific settings that are unrelated to the financial settings. For example, at step 102c, the customer end 12b may send to the provider end 12a one or more of the following preferences: 1) when the organization would like to, for example: have invoices sent out on a scheduled basis, 2) when the organization would like invoice payments due, 3) how many days before an unpaid invoice is considered to be late, and the like.

In an implementation, the sub-step 128 includes user groups and security settings (i.e., full access vs. read only) that are sent from the customer end 12b to the provider end 12a. In an implementation, sub-step 130 includes the customer end 12b informing the provider end 12a with organizational hierarchy information such that, for example, the provider end 12a may know which individual or group at the customer end may access cash or accounting information. In an implementation, sub-step 132 includes the customer end 12b informing the provider end 12a with invoice/statement preferences (e.g., when invoices should be sent out and when payment is due). In an implementation, sub-step 134 includes the customer end 12b providing the provider end 12a with check approval (i.e., spending money) guidance (e.g., who, at the customer end 12b, is permitted to authorize payment to a vendor). In an implementation, sub-step 136 includes the customer end 12b providing the provider end 12a with late fee settings. In an implementation, sub-step 138 optionally includes the provider end 12a meeting with one or more persons associated with the customer end 12b to finalize designated settings and/or to conduct training on how the services provided by the provider end 12a are to be utilized.

A fourth step 102d of the method 100 is generally referred to as “verifying information by electronically transferring sample data from the provider end 12a to the customer end 12b” and includes sub-steps 140-150. In an implementation, the verifying information by transferring sample data from the provider end to the customer end step 102d may be conducted in order to verify the preferences provided at step 102c.

In an implementation, sub-step 140 includes the provider end 12a sending an information upload template to the customer 12b. In an implementation, sub-step 142 includes the customer end 12a providing the provider end 12a with hierarchy data (e.g., chapter information, officer information and member information) that corresponds to data identified in the upload template. In an implementation, sub-step 148 includes the provider end 12a reviewing the setup process with the customer end 12b. In an implementation, sub-step 150 includes verifying the template data and testing communications between the provider end 12a and the customer end 12b prior to executing any actual cash transactions and associated accounting.

In an embodiment, the third and fourth steps 102c-102d are provided in this disclosure for exemplary purposes for a particular type of customer at the customer end 12b that is structured in the form of, for example, an organization including, for example, members of a chapter with the chapter being one of a plurality of chapters that are subject to headquarters of the organization. In an implementation, the headquarters may be a nationally-organized Greek society, and, the chapters may be local chapters of the Greek society located at, for example, college campuses/universities, and, the members may be a stakeholder of a particular chapter of the plurality of chapters.

Accordingly, in view of the organizational example described above, the following implementation of the system 10 at FIGS. 3-9C may be based upon an exemplary hierarchy including a member/chapter/headquarter. As such, it will be appreciated that the third and forth steps 102c-102d, as well as the following discussion at FIGS. 3-9C, are exemplary for an application-specific embodiment of a member/chapter/headquarter hierarchy and should not be utilized to otherwise limit the disclosure. Although the exemplary embodiment described in this disclosure may be directed to a member/chapter/headquarter model (that may be associated with, e.g., a nationally-organized Greek society), it will be appreciated that the exemplary embodiment is not limited to a member/chapter/headquarter model associated with, e.g., a nationally-organized Greek society and that the invention may be practiced by any non-incorporated/incorporated organization or group. Further, although the exemplary embodiments described in this disclosure may be directed to a member/chapter/headquarter model, other organizational models may be applied to the system 10, such as, for example: a singular company/corporation including, for example, (a) department(s) as well as one or more persons that is/are included in the department(s). Other organizational models may alternatively include, but are not limited to a relationship between for example: (A) customer/headquarters, (B) customer/division/headquarters, (C) customer/franchisee/headquarters, or the like. Further, in an implementation, any organization that may utilize the system 10 may or may not be incorporated in the form of, for example, a non-profit or for-profit organization.

III. Exemplary Methods 200-400 for Using the System 10

Upon completing the steps associated with the method 100 for initializing the customer end 12b with the provider end 12a, an exemplary presentation of and use of the web-page content 22 by a customer at the customer end 12b is described according to an implementation at FIGS. 3-9C. In an implementation, FIGS. 3-4D are directed to a billing methodology 200 such that a chapter of the organization may send an invoice to one or more members of the chapter. In an implementation, FIGS. 5-6D are directed to a payment methodology 300 such that the one or more members associated with the chapter make a payment to the chapter. In an implementation, FIGS. 7-8E are directed to spending methodology 400 such that the chapter makes a payment to a vendor.

In the foregoing disclosure at FIGS. 4A-4D, 6A-6D and 8A-8E, reference characters “A” and “C” are shown superimposed on the illustrated web-page content 22. Reference character “A” indicates an “accountancy selection” or “accountancy data entry” provided by a user of the web-page 22. Reference character “C” indicates a “cash management selection” or “cash management data entry” provided by a user of the web-page content 22. Accordingly, the selections or data entry associated with the reference characters “A” and “C” may be referred to as inputs for the “virtual cash handling and accountancy services” provided from the customer end 12b to the provider end 12a. Accordingly, cash selections/data entries, C, may be processed by or acted upon by the cash module sub-processor 14e″ whereas accountancy selections/data entries, A, may be processed by or acted upon by the accounting module processor 14e′.

In an exemplary implementation, it will be appreciated that the methodologies 200-400 relate, in tandem, any credit/debit cash activity, C, of a customer's banking account at the financial institution end 12c to an underlying accounting activity, A, in real-time on a transaction-by-transaction basis such that the “virtual cash handling and accountancy services” do not permit any form of a credit/debit cash activity, C, or entry to occur without a corresponding occurrence of an accounting activity, A, or entry (i.e., the “virtual cash handling and accountancy services” operates on the principle that cash activity, C, is never separate from accounting activity, A). Thus, as seen in FIGS. 9B-9C, the provider end 12a may ultimately provide an output of web-page content 22 of all of the cash and accounting activity, C, A, such that the provider end 12a will be able to generate, for example, real-time, entry-by-entry GAAP-compliant financial reports in the form of, for example, balance sheets (see, e.g., FIG. 9B) and income statements (see, e.g., FIG. 9C).

Referring now to FIGS. 3-4D, an implementation of the billing methodology 200 for a chapter of an organization sending invoices to one or more members associated with the chapter is discussed. According to an implementation, the method 200 includes several steps 202a-202d with each step 202a-202d having a plurality of sub-steps 204-210, 212-218, 220-228 and 230-232.

According to an implementation, a customer (e.g., a fiduciary of the chapter, such as, for example, a treasurer of the chapter) at the customer end 12b accesses web-page content 22 from the provider end 12a. As seen in FIGS. 4A-4D, the web-page content 22 associated with the billing methodology 200 guides the fiduciary of the chapter through four billing steps 202a-202d for billing members of a chapter including: “Select Members” (see, e.g., step 202a in FIG. 3), “Enter Fee Details” (see, e.g., step 202b in FIG. 3), “Enter Fee Amount” (see, e.g., step 202c in FIG. 3) and “Confirm” (see, e.g., step 202d in FIG. 3).

Referring to FIG. 4A, the “Select Members” step 202a is discussed. Firstly, the fiduciary selects from a first pull-down button, a “Billing Type,” A, and, from a second pull-down button, a “Member Status” (see, e.g., sub-step 204 in FIG. 3). Then, the fiduciary may import/export members of the chapter from a “group of total members field” and a “selected member” field by, for example, highlighting one or more members in one of the fields (see, e.g., sub-step 206 in FIG. 3) and subsequently clicking on a left/right arrow button (see, e.g., sub-step 208 in FIG. 3). Once the fiduciary has selected members of the chapter that are to be invoiced with a bill, the fiduciary clicks the “Next” button (see, e.g., sub-step 210 in FIG. 3).

Upon clicking the “Next” button, the displayed web-page content 22 changes from what is shown in FIG. 4A to what is shown in FIG. 4B in order to conduct the “Enter Fee Details” step 202b. In FIG. 4B, the fiduciary selects from a pull-down button, a “Statement Date,” A, that will be the day that the selected members will receive the invoice (see, e.g., sub-step 212 in FIG. 3). Then, in FIG. 4B, the fiduciary may enter text in a “Description” field, A, that will appear on the invoice to the selected members (see, e.g., sub-step 214 in FIG. 3). Then, in FIG. 4B, the fiduciary selects from a pull-down button, a “Billing Period,” A, that will be assigned to the sent invoice such that the billed fee to the selected members may be associated with a specific billing period (see, e.g., sub-step 216 in FIG. 3). Once the fiduciary has made the above discussed selections, the fiduciary clicks the “Next” button (see, e.g., sub-step 218 in FIG. 3), or, alternatively, make click the “Back” button if it has been determined that any members should be added or deleted from the selected members in the selected members field.

Upon clicking the “Next” button, the displayed web-page content 22 changes from what is shown in FIG. 4B to what is shown in FIG. 4C in order to conduct the “Enter Fee Amount” step 202c. In FIG. 4C, the fiduciary selects from a pull-down button, a “Reporting Category,” (see, e.g., sub-steps 220, 222 in FIG. 3) A, in order to associate the invoiced amount with a particular fee, due or the like. Then, in FIG. 4C, the fiduciary enters an amount, C, to be invoiced to the selected members (see, e.g., sub-step 224 in FIG. 3). If additional reporting categories are needed, the fiduciary clicks on “Add Row” (see, e.g., sub-step 226 in FIG. 3). Once the fiduciary has made the above discussed selections, the fiduciary clicks the “Next” button (see, e.g., sub-step 228 in FIG. 3), or, alternatively, may click the “Back” button if it has been determined that previously-entered/-selected data by the fiduciary should be changed.

Upon clicking the “Next” button, the displayed web-page content 22 changes from what is shown in FIG. 4C to what is shown in FIG. 4D in order to conduct the “Confirm” step 202d. In FIG. 4D, the fiduciary analyzes/verifies the displayed invoice details (see, e.g., sub-step 228 in FIG. 3). If the fiduciary agrees with what is displayed, the fiduciary clicks the “Submit” button (see, e.g., sub-step 323 in FIG. 3) in order to submit the invoice to the provider end 12a such that the provider end 12a may subsequently broadcast/send an invoice or notice (within, for example, one or more emails) corresponding to the displayed invoice details to each member that was selected at step 202a.

Referring now to FIGS. 5-6D, an implementation of the payment methodology 300 for permitting one or more members associated with the chapter to make a payment to the chapter is discussed. According to an implementation, the method 300 includes several steps 302a-302d with each step 302a-302d having a plurality of sub-steps 304-310, 312-316, 318-322 and 324.

According to an implementation, a customer (e.g., a member of the chapter) at the customer end 12b accesses web-page content 22 from the provider end 12a. As seen in FIGS. 6A-6D, the web-page content 22 associated with the payment methodology 300 guides the member of the chapter through four payment steps 302a-302d for making a payment to the chapter including: “Indicate Payment Amount” (see, e.g., step 302a in FIG. 5), “Indicate Payment Method” (see, e.g., step 302b in FIG. 5), “Authorize Payment” (see, e.g., step 302c in FIG. 5) and “Confirm” (see, e.g., step 302d in FIG. 5).

Referring to FIG. 6A, the “Indicate Payment Amount” step 302a is discussed. Firstly, the member may click on one or two radio buttons (e.g., “Pay current amount due” or “I'd like to pay a different amount”); in the illustrated embodiment, the member selects the “I'd like to pay a different amount” radio button (see, e.g., sub-step 304 in FIG. 5). Then, the member may click on a drop-down arrow in order to select, for example, “Select Specific Charges” (see, e.g., step 306 in FIG. 5). Then, then member may click on one or more check boxes that may, for example, correlate to one or more scheduled amounts, A, C, invoiced, amounts, (sent according to, e.g., method 200) A, C, or the like (see, e.g., step 308 in FIG. 5). Once the member has made the above-identified selections, the member clicks the “Next” button (see, e.g., sub-step 310 in FIG. 5).

Upon clicking the “Next” button, the displayed web-page content 22 changes from what is shown in FIG. 6A to what is shown in FIG. 6B in order to conduct the “Indicate Payment Method” step 302b. In FIG. 6B, the member clicks on a drop-down menu in order to select the Payment Method (i.e., the location of a source of funds such as, for example, the member's banking account at the financial institution end 12c) that the member wishes to utilize to make the payment, C, to the chapter (see, e.g., sub-step 312 in FIG. 5). Then, in FIG. 6B, the customer clicks on the remaining fields (e.g., “Account Holder Name,” “Check Number,” “Account Number,” “Re-Enter Account Number,” “Yes, I would like to store this information for future payments”) and enters corresponding data into the fields (see, e.g., sub-step 314). Once the member has made the above discussed selections, the member clicks the “Next” button (see, e.g., sub-step 316 in FIG. 5), or, alternatively, may click the “Back” button if it has been determined that any of the previous selections should be changed.

Upon clicking the “Next” button, the displayed web-page content 22 changes from what is shown in FIG. 6B to what is shown in FIG. 6C in order to conduct the “Authorize Payment” step 302c. In FIG. 6C, the member analyzes/reviews the previously-entered data from steps 302a, 302b and may optionally enter an email address in order to receive a confirmation that the payment was sent (see, e.g., sub-step 318 in FIG. 5). Then, in FIG. 6C, the member clicks on a box that indicates that “I have read and I accept the terms and conditions” (see, e.g., sub-step 320 in FIG. 6C). Once the customer has made the above discussed selections, the customer clicks the “Submit” button (see, e.g., sub-step 322 in FIG. 5), or, alternatively, make click the “Back” or “Cancel” buttons if it has been determined that any of the previous selections should be changed or cancelled.

Upon clicking the “Next” button, the displayed web-page content 22 changes from what is shown in FIG. 6C to what is shown in FIG. 6D in order to conduct the “Confirm” step 302d. In FIG. 6D, the web-page content 22 indicates that the payment, C, has been submitted (see, e.g., sub-step 324 in FIG. 5). Thus, in an implementation, the cash module processor 14e″ of the “virtual cash handling and accountancy services” provided by the provider end 12a acts in a manner such that the provider end 12a is instructed/authorized/charged with brokering the payment from the member (i.e., the payer) to the chapter by moving funds, C, from the member's banking account at the financial institution end 12c to the chapter's banking account at the financial institution end 12c (see steps 6a, 6b of FIG. 1A) all while the accounting module processor 14e′ accounts for accounting activity, A, associated with the authorized payment transaction.

Referring now to FIGS. 7-8ED, an implementation of the payment methodology 400 for a chapter of an organization sending a payment to one or more vendors is discussed. According to an implementation, the method 400 includes several steps 402a-402d with each step 402a-402d having a plurality of sub-steps 404-418, 420-422, 424-426 and 428-432.

According to an implementation, a customer (e.g., a fiduciary of the chapter such as, for example, a treasurer of the chapter) at the customer end 12b accesses web-page content 22 from the provider end 12a. As seen in FIGS. 8A-8E, the web-page content 22 associated with the payment methodology 400 guides the fiduciary of the chapter through four payment steps 402a-402d for making a payment to the vendor including: “Entering Check Details” (see, e.g., step 402a in FIG. 7), “Preview Check Details” (see, e.g., step 402b in FIG. 7), “Check Approval” (see, e.g., step 402c in FIG. 7) and “Print Check” (see, e.g., step 402d in FIG. 7).

Referring to FIG. 8A, the “Entering Check Details” step 402a is discussed. Firstly, the fiduciary clicks on a “Cash Out” tab of the web-page content 22 in order to start the process for permitting the fiduciary to create a virtual check, VC (see FIG. 8C), that may serve as a basis for payment, C, to a vendor. Prior to further discussing the methodology 400 at FIGS. 8A-8E, additional check data/information pertaining to the creation of the virtual check, VC, may arise from/be sent to a third party end 12d; in an implementation, the third party end 12d may be, for example, a check services company, such as, for example, ADP® that communicates with the provider end 12a for sending/receiving check data/information that may be utilized for authenticating/creating the virtual check, VC.

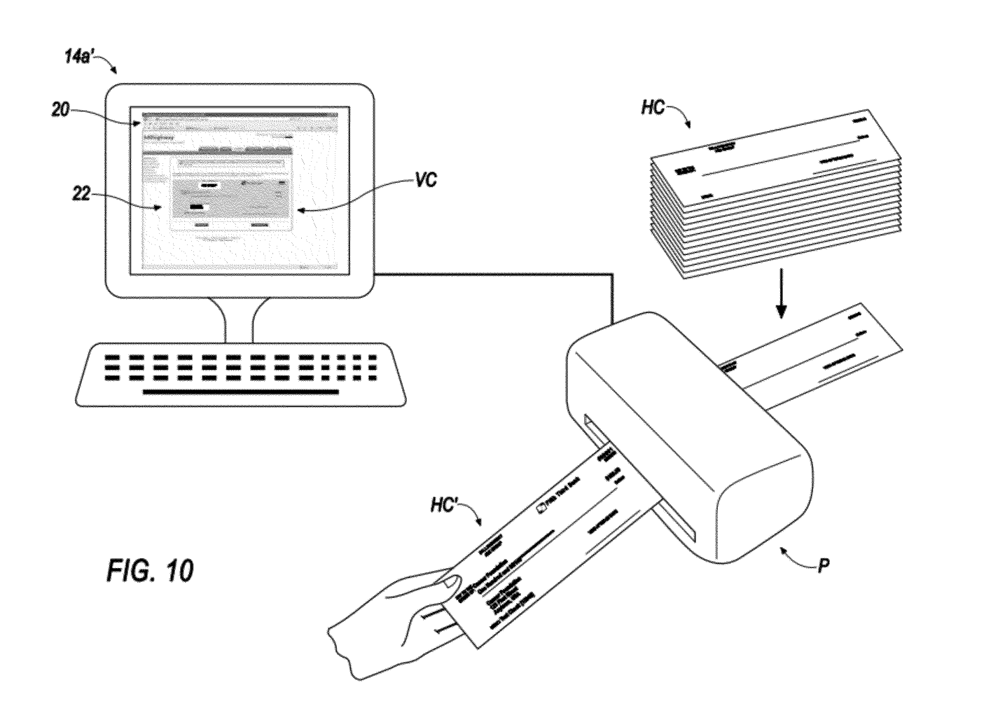

Referring to FIG. 8A, from a first pull-down button, the fiduciary selects a banking account, C, of the chapter that may be located at the financial institution end 12c in order to associate an amount of funds, C, from the banking account with the virtual check, VC, to be provided (see, e.g., steps 1′, 2′ of FIG. 1B) to the vendor (see, e.g., step 404 in FIG. 7). Subsequently, as will be explained in the disclosure, if desired, the virtual check, VC, may be prepared in the form of a hardcopy, HC′ (see FIG. 10), by the customer at the customer end 12b such that the hardcopy, HC′, may be subsequently sent (see, e.g., steps 1′, 2′ of FIG. 1B) to the vendor from the customer at the customer end 12b.

Then, from a second pull-down button, the fiduciary selects a vendor that will receive, A, the virtual check, VC,/hardcopy check, HC′ (see, e.g., step 406 in FIG. 7). Then, from a third pull-down button, the fiduciary associates the virtual check, VC, with a billing period by selecting a billing period, (see, e.g., step 408 in FIG. 7) A. Then, the fiduciary enters data into the “Check Number” field, A, in order to give a number to the virtual check, VC, (see, e.g., step 410 in FIG. 7). Then, the fiduciary enters data, A, into the “Memo” field in order to associate a memorandum with the virtual check, VC, (see, e.g., step 412 in FIG. 7). Then, from a fourth pull-down button, the fiduciary associates the virtual check, VC, with a chart of accounts, A, by selecting a chart of accounts (see, e.g., step 414 in FIG. 7). Then, the fiduciary enters data into the “Check Amount” field, C, A, in order to associate an amount of funds with the virtual check, VC, that may be drawn from the chapter's selected banking account (see, e.g., step 416 in FIG. 7) at the financial institution end 12c. Once the fiduciary has provided the above information, the fiduciary clicks the “Add To Check Details” button (see, e.g., step 418 in FIG. 7).

Upon clicking the “Add To Check Details” button, the displayed web-page content 22 changes from what is shown in FIG. 8A to what is shown in FIG. 8B in order to conduct the “Preview Check Details” step 402b. As seen in FIG. 8B, the web-page content 22 appears to be substantially similar to what is shown in FIG. 8A with the exception that the previously entered/selected data is reproduced with two additional buttons (i.e., a “Reset” button and a “Preview Check” button) also being displayed. To proceed to the next step, the fiduciary clicks the “Preview Check” button (see, e.g., step 420 in FIG. 7). Upon clicking the “Preview Check” button, the displayed web-page content 22 changes from what is shown in FIG. 8B to what is shown in FIG. 8C.

In FIG. 8C, the web-page content 22 displays the virtual check, VC, that includes the previously-entered data/selections, and, in addition to the virtual check, VC, two additional buttons (i.e., a “Edit Check” button and a “Create Check” button) are displayed. If the fiduciary wishes to change any of the details of the virtual check, VC, the fiduciary may click the “Edit Check” button; alternatively, if the fiduciary finds the details of the virtual check, VC, to be acceptable, the fiduciary may click the “Create Check” button (see, e.g., step 422 in FIG. 7).

Upon clicking the “Create Check” button, the displayed web-page content 22 changes from what is shown in FIG. 8C to what is shown in FIG. 8D in order to conduct the “Check Approval” step 402c. As seen in FIG. 8D, a listing of one or more virtually-created checks, VC, are shown. The fiduciary may select one or more of the one or more virtually-created checks, VC, by clicking on a box next to the virtually-created check, VC (see, e.g., step 424 in FIG. 7). If the fiduciary elects to not utilize any of the virtually-created checks, VC, the fiduciary may click on the “Deny” button, virtually voiding the virtually-created check, VC; alternatively, if the fiduciary wishes to approve any of the virtual checks, VC, the fiduciary may click the “Approve” button such that one or more of the virtually-created checks, VC, is/are fully prepared for endorsement by the intended vendor (see, e.g., step 426 in FIG. 7).

Upon clicking the “Approve” button, the displayed web-page content 22 changes from what is shown in FIG. 8D to what is shown in FIG. 8E in order to conduct the “Print Check” step 402d. As seen in FIG. 8E, the fiduciary may select a billing period, A, that the approved virtually-created check, VC, should be associated with (see, e.g., step 428 in FIG. 7). Then, the fiduciary may elect to email (see steps 1′, 2′ of FIG. 1B) the virtual check, VC, to, for example, the vendor, by clicking on, for example, an “Email” button. Further, the fiduciary may elect to create a useable hardcopy check, HC′ (see FIG. 10), that corresponds to the virtual check, VC, by clicking on a “Print” button (see, e.g., step 430 in FIG. 7). As seen in FIG. 10, prior to or subsequent to clicking on the “Print” button, the fiduciary may load physical, paper-based check stock material, HC (see FIG. 10), that may be provided from the provider end 12a to the customer at the customer end 12b into a printer, P (see FIG. 10), for creating the physical hardcopy check, HC′, in view of the virtually-created virtual check details (see, e.g., step 432 in FIG. 7) associated with the virtual check, VC. In an implementation, if the virtual check, VC, is emailed to the vendor, the vendor may include a similar printer, P, and utilize the virtual check details within the email to print a hardcopy, HC′, of the virtual check, VC.

In an implementation, the printer, P, may include, for example, an ink cartridge (not shown) including, for example, (a) conventional ink cartridge(s), (b) magnetic ink cartridge(s) or the like. If magnetic ink is used, the magnetic ink may permit printed portions of the physical hardcopy check, HC′, to be recognized by, for example, Magnetic Ink Character Recognition (MICR) check processing systems (not shown).

Referring to FIGS. 9A-9C, web-page content 22 associated with the virtual cash handling and accountancy services occurring from, for example, the methods 100-400 may be provided from the provider end 12a. For example, in FIG. 9A, the fiduciary may click on a “Reports” tab of the web-page content 22 in order to permit the fiduciary to create AAI produced real-time, entry-by-entry GAAP-compliant financial reports that may include, but is not limited to, for example, a Balance Sheet (see, e.g., FIG. 9B), an Income Statement (see, e.g., FIG. 9C) and the like.

Because the AAI produced real-time, entry-by-entry GAAP-compliant financial reports at the provider end 12a, a customer (e.g., a fiduciary of a chapter of an organization) at the customer end 12b may submit up-to-date, GAAP-compliant financial reports to other stakeholders (e.g., a CPA at the Professional Accountant End 12e, an IRS agent at the Government End 12f or the like) that may need access to the customer's financial information. Additionally, the customer may provide the up-to-date, GAAP-compliant financial reports to other stakeholders in any desirable manner, such as, for example, by permitting the stakeholders at the ends 12e, 12f access to the customer's account at the provider end 12a by way of, for example, the Internet 16d.

Accordingly, in an implementation, when the customer at the customer end 12b attends to, for example, an end-of-the-year financial analysis, the customer may permit a CPA at the Professional Accountant End 12e to electronically access the customer's virtual cash handling and accountancy services account at the provider end 12a in order to permit the CPA to examine the “virtual account's” accounting in view of data entries/selections provided by the customer. Accordingly, the CPA may easily identify/verify if the customer's data entries/selections are properly classified, as, for example, taxable or deductible events, A. Accordingly, in an implementation, the CPA may be able to easily and appropriately analyze the accuracy of the customer's transactions in order to potentially identify if, for example, the customer improperly recorded an entry as a deductible, A, when the entry should be been associated with a taxable event, A. As such, in an implementation, the CPA at the Professional Accountant End 12e may utilize the financial reports shown, for example, in FIGS. 9B, 9C in order to more easily prepare and file tax statements for the customer at the customer end 12b with the IRS at the government end 12f.

In addition to the benefit of being able to provide up-to-date, GAAP-compliant financial reports, the “virtual cash handling and accountancy services” provided from the provider end 12a may also yield other benefits. For example, headquarters of an organization may solicit the virtual cash handling and accountancy services from the provider end 12a in order to assert a form of financial guidance and control over chapters; for example, the headquarters of the organization may provide the provider end 12a with pre-defined financial statement standards, naming conventions and the like such that each chapter of the organization subscribing to the virtual cash handling and accountancy services is forced to comply with the headquarters' financial reporting wishes; in other words, by forcing each chapter to follow a common standard, headquarters of the organization may have improved financial oversight capabilities of each chapter as well as improved access to chapter data for comparatively analyzing financial trends and statistics for all chapters.

Further, headquarters, or, alternatively, a chapter may be able to identify, mitigate, or, in some circumstance, eliminate potential instances of fraud, if, for example, a fiduciary of the chapter is, for example, embezzling funds from the chapter's banking account at the financial institution end 12c. Accordingly, in an embodiment, if the fiduciary attempts to conduct the vendor payment method 300 by identifying himself/herself as a vendor to be paid an amount from the chapter's account at the financial institution end 12c, the provider end 12a may flag or prevent payment to occur, and/or, alternatively, alert headquarters of the potential fraudulent use of the “virtual cash handling and accountancy services.” Such an occurrence of fraud may arise when the fiduciary, for example, attempts to enter “miscellaneous” in a field when the attempted payment is created; alternatively, in some circumstances, headquarters may provide instructions to the provider end 12a to prevent “miscellaneous” to be utilized in a field in order to make it difficult for the fiduciary to subterfuge the attempt to defraud the chapter from funds.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method, comprising the steps of:
accessing, at a computer at a customer end, Internet web-page content from a provider end for obtaining access to virtual cash handling and accountancy services from an application server of the provider end for managing financial data, wherein the financial data includes one or more cash handling data entries and one or more accountancy data entries;
utilizing a cash module processor of the application server for causing the provider end to broker movement of cash funds to/from a customer end financial institution cash account at a customer end financial institution that is associated with the customer end and a payer/payee end financial institution cash account at a payer/payee end financial institution that is associated with a payer/payee end by way of a provider end financial institution cash account at a provider end financial institution that is associated with the provider end, wherein the cash module processor is utilized for conducting the steps of
interfacing with a financial institution database associated with one or more financial institution ends including the customer end financial institution, the payer/payee end financial institution and the provider end financial institution for
executing a customer-end authorized cash handling movement instruction that is received by the provider end for the purpose of
moving an amount of cash funds to/from the customer end financial institution cash account at the customer end financial institution and the payer/payee end financial institution cash account at the payer/payee end financial institution by way of the provider end financial institution cash account at the provider end financial institution;
utilizing the cash module processor of the application server for processing the one or more cash handling data entries, wherein the processing the one or more cash handling data entries step includes the step of
creating one or more cash handling journal entries that is/are written to a virtual real-time, true cash ledger, wherein the virtual real-time, true cash ledger contributes to a virtual financial statement; and
utilizing an accounting module processor of the application server for processing the one or more accountancy data entries, wherein the processing the one or more accountancy data entries step includes the step of
creating one or more accounting journal entries that is/are written to a virtual general ledger, wherein the virtual general ledger contributes to the virtual financial statement, wherein, responsive to one of the creating one or more cash handling journal entries step and the creating one or more accounting journal entries step, further comprising the step of
utilizing the application server for reconciling the one or more cash handling data entries with the one or more accountancy data entries.

2. The method according to claim 1, further comprising the step of storing the financial data in a database at the provider end.

3. The method according to claim 1, wherein the accessing step includes retrieving the Internet web-page content from a web server at the provider end.

4. The method according to claim 1, further comprising the step of
utilizing the computer at the customer end for
viewing the virtual financial statement, wherein the virtual financial statement comprises at least a portion of the Internet web-page content.

5. The method according to claim 1, wherein the obtaining access to virtual cash handling and accountancy services from the provider end step further comprises the step of
creating a virtual check at the customer end from the accessed Internet web-page content from the provider end.

6. The method according to claim 5, wherein after the creating the virtual check step, further comprising the step of
sending/receiving check data associated with the virtual check to/from the provider end and a third party data provider end for
authenticating the virtual check.

7. The method according to claim 1, wherein after the reconciling step, further comprising the step of
generating a Generally Accepted Accounting Principles (GAAP) compliant virtual financial statement.

8. A method, comprising the steps of:
accessing, at a computer at a customer end, Internet web-page content from a provider end for
obtaining access to virtual cash handling and accountancy services from the provider end for
managing financial data, wherein the financial data includes
one or more cash handling data entries, and
one or more accountancy data entries, wherein the managing step further includes the step of
reconciling the one or more cash handling data entries with the one or more accountancy data entries.

9. The method according to claim 8, further comprising the step of
storing the financial data in a database at the provider end.

10. The method according to claim 8, wherein the accessing step includes
retrieving the Internet web-page content from a web server at the provider end.

11. The method according to claim 8, wherein the obtaining step includes
retrieving the virtual cash handling and accountancy services from an application server at the provider end.

12. The method according to claim 11, wherein, responsive to managing one or more cash handling data entries, further comprising the step of
utilizing the application server for causing the provider end to broker movement of cash funds
to/from
a customer end financial institution cash account at a customer end financial institution that is associated with the customer end and
a payer/payee end financial institution cash account at a payer/payee end financial institution that is associated with a payer/payee end by way of
a provider end financial institution cash account at a provider end financial institution that is associated with the provider end.

13. The method according to claim 12, further comprising the steps of
utilizing a cash module processor of the application server at the provider end for performing the step of causing the provider end to broker the movement of cash funds step, wherein the cash module processor is utilized for conducting the steps of
interfacing with a financial institution database associated with one or more financial institution ends including the customer end financial institution, the payer/payee end financial institution and the provider end financial institution for
executing a customer-end authorized cash handling movement instruction that is received by the provider end for the purpose of
moving an amount of cash funds to/from the customer end financial institution cash account at the customer end financial institution and the payer/payee end financial institution cash account at the payer/payee end financial institution by way of the provider end financial institution cash account at the provider end financial institution.

14. The method according to claim 11, further comprising the steps of
utilizing a cash module processor of the application server for processing the one or more cash handling data entries; and
utilizing an accounting module processor of the application server for processing the one or more accountancy data entries.

15. The method according to claim 14, wherein the processing the one or more cash handling data entries step includes the step of
creating one or more cash handling journal entries that is/are written to a virtual real-time, true cash ledger, wherein the virtual real-time, true cash ledger contributes to a virtual financial statement, wherein the processing the one or more accountancy data entries step includes the step of
creating one or more accounting journal entries that is/are written to a virtual general ledger, wherein the virtual general ledger contributes to the virtual financial statement.

16. The method according to claim 15, wherein, responsive to one of the creating one or more cash handling journal entries step and the creating one or more accounting journal entries step, further comprising the step of
utilizing the application server to conduct the reconciling step.

17. The method according to claim 15, further comprising the step of
utilizing the computer at the customer end for
viewing the virtual financial statement, wherein the virtual financial statement comprises at least a portion of the Internet web-page content.

18. The method according to claim 8, wherein the obtaining access to virtual cash handling and accountancy services from the provider end step further comprises the step of
creating a virtual check at the customer end from the accessed Internet web-page content from the provider end.

19. The method according to claim 18, wherein after the creating the virtual check step, further comprising the step of
sending/receiving check data associated with the virtual check to/from the provider end and a third party data provider end for
authenticating the virtual check.

20. The method according to claim 8, wherein after the reconciling step, further comprising the step of
generating a Generally Accepted Accounting Principles (GAAP) compliant virtual financial statement.

21. A system, comprising:
a web server at a provider end including virtual cash handling and accountancy services web-page content;
means for
obtaining access to the virtual cash handling and accountancy services web-page content from the provider end, and
communicating one or more cash handling data entries and one or more accountancy data entries from a customer end to the provider end; and
means for
reconciling the one or more cash handling data entries with the one or more accountancy data entries at the provider end, and
generating a Generally Accepted Accounting Principles (GAAP) compliant virtual financial statement at the provider end.

22. The system according to claim 21, further comprising
means for storing the financial data at the provider end.

23. The system according to claim 21, further comprising
means for causing the provider end to broker movement of cash funds to/from a customer end financial institution cash account at a customer end financial institution that is associated with the customer end and a payer/payee end financial institution cash account at a payer/payee end financial institution that is associated with a payer/payee end by way of a provider end financial institution cash account at a provider end financial institution that is associated with the provider end.

24. The system according to claim 21, further comprising
means for interfacing with a financial institution database associated with one or more financial institution ends including the customer end financial institution, the payer/payee end financial institution and the provider end financial institution for executing a customer-end authorized cash handling movement instruction that is received by the provider end for the purpose of moving an amount of cash funds to/from the customer end financial institution cash account at the customer end financial institution and the payer/payee end financial institution cash account at the payer/payee end financial institution by way of the provider end financial institution cash account at the provider end financial institution.

25. The system according to claim 21, further comprising
means for processing the one or more cash handling data entries for creating one or more cash handling journal entries that is/are written to a virtual real-time, true cash ledger, wherein the virtual real-time, true cash ledger contributes to a virtual financial statement; and
means for processing the one or more accountancy data entries for creating one or more accounting journal entries that is/are written to a virtual general ledger, wherein the virtual general ledger contributes to the virtual financial statement.

26. The system according to claim 25, further comprising
means for viewing the virtual financial statement, wherein the virtual financial statement comprises at least a portion of the virtual cash handling and accountancy services Internet web-page content.

27. The system according to claim 21, further comprising
means for creating a virtual check at the customer end from the accessed virtual cash handling and accountancy services Internet web-page content from the provider end.

28. The system according to claim 27, further comprising
means for sending/receiving check data associated with the virtual check to/from the provider end and a third party data provider end for authenticating the virtual check.
